(19) United States
(12) Patent Application Publication
(10) Pub. No.: US 2008/0189679 A1
(43) Pub. Date: Aug. 7, 2008

(54) METHOD AND SYSTEM FOR CREATING, DEPLOYING, AND UTILIZING A SERVICE

(76) Inventors: JARED RODRIGUEZ, Tampa, FL (US); Jack KENNEDY, Tarpon Springs, FL (US); Mike WEAVER, Seminole, FL (US)

Correspondence Address: DLA PIPER US LLP, P. O. BOX 9271, RESTON, VA, 20195, US

(21) Appl. No.: 12/023,488

(22) Filed: Jan. 31, 2008

Related U.S. Application Data
(60) Provisional application No. 60/888,239, filed on Feb. 5, 2007.

(51) Int. Cl. G06F 9/44

(52) U.S. Cl. 717/105

(57) ABSTRACT

A system and method of utilizing a service, comprising: designing the service in a visual modeling environment such that low level machine centric and/or platform dependent programming language is not used, the service capable of being implemented across an enterprise; and deploying the service in a plurality of technology infrastructures within the enterprise in a manner that interacts with enterprise software and/or other technology infrastructures by tailoring the service for each such infrastructure.

This application claims priority to U.S. provisional 60/888,239, filed on Feb. 5, 2007, and entitled “Method and System for Creating, Deploying, and Utilizing a Service”, which is herein incorporated by reference.

### BRIEF DESCRIPTION OF THE DRAWINGS

FIGS. 1-14 illustrate a system for creating, deploying, and utilizing a service in a visual modeling environment, according to one embodiment of the invention.

FIGS. 15-25 illustrate methodology for creating, deploying, and utilizing a service in a visual modeling environment, according to one embodiment of the invention.

FIGS. 26-46 illustrate screen shots for creating, deploying, and utilizing a service in a visual modeling environment, according to one embodiment of the invention.

### DESCRIPTION OF EMBODIMENTS OF THE INVENTION

### System Components

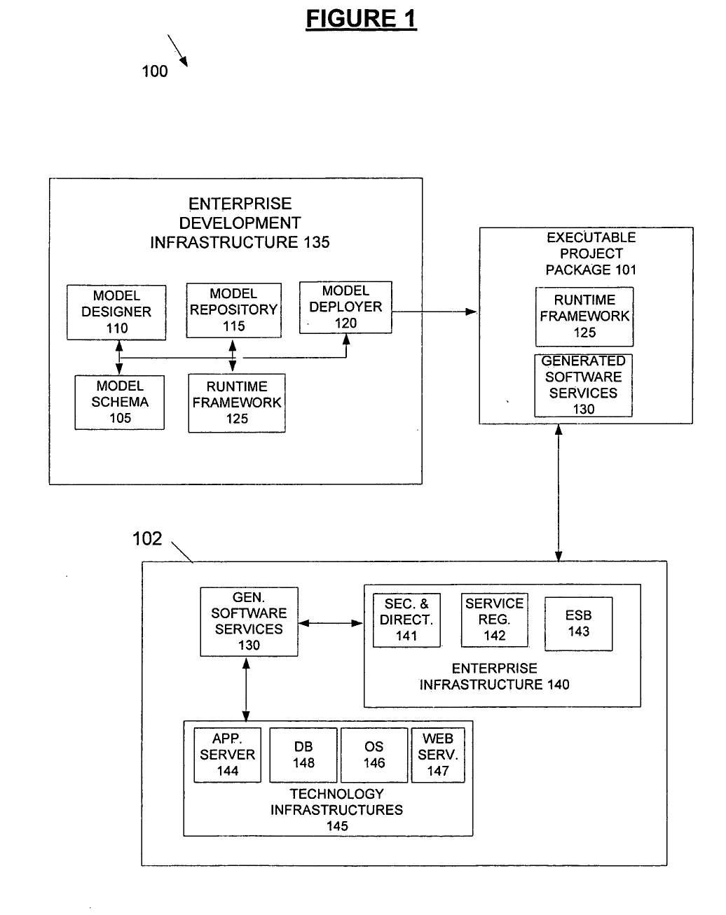

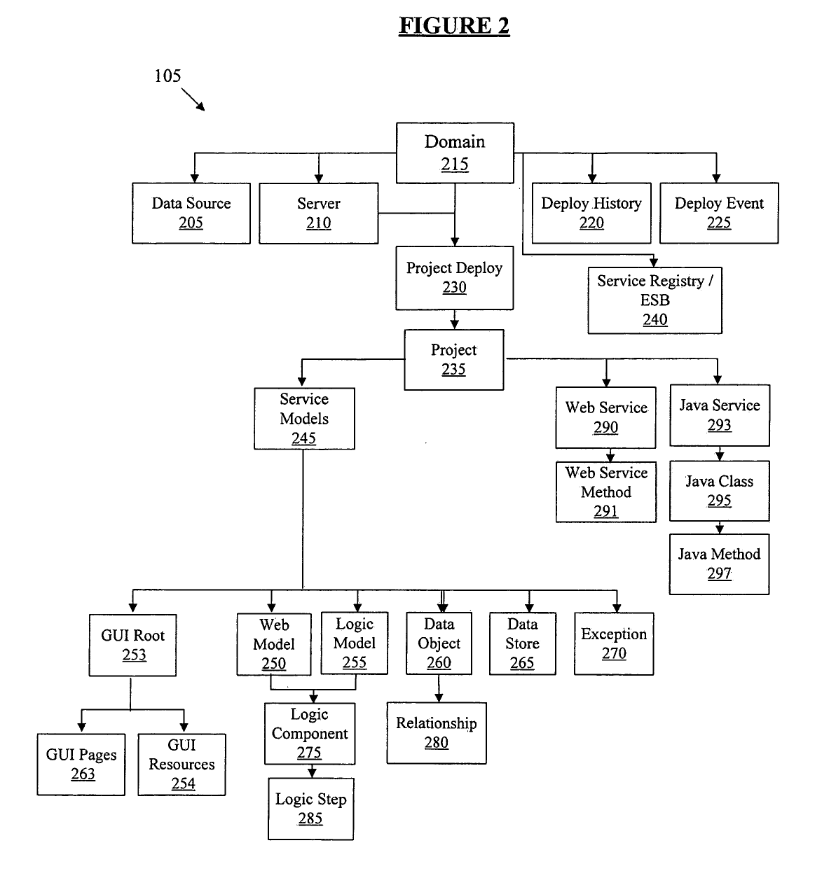

FIG. 1 illustrates a system for creating a service in a visual modeling environment, according to one embodiment of the invention. An enterprise 100 includes enterprise development infrastructure 135 and an enterprise software environment 102. An enterprise is an organization that utilizes various technologies. The enterprise development infrastructure 135 creates an executable project package 101 including generated software services 130 and a runtime framework 125. The term “services” throughout this patent is intended to refer to services, applications and/or software or the like. The executable project package 101 is executed in the enterprise software environment 102. Within the enterprise software environment 102, various technology infrastructures 145 are scattered across the enterprise 100. Technology infrastructures 145 execute the generated software services 130 in accordance with the runtime framework 125. At the same time, the generated software services 130 are integrated with the enterprise infrastructure 140. The enterprise infrastructure 140 comprises software, such as security and directory services 141, service registries 142, and enterprise service buses 143, designed to provide common services to technology infrastructures 145. The technology infrastructures 145 include, for example, applications servers 144, databases, 148, operating systems 146, and/or web servers 147.

The enterprise development infrastructure 135 creates service models. The service models are created in a visual modeling environment, which is an environment of objects that are simplified, easy to build or assemble, but still recognizable as a representation of the original item being modeled. A visual modeling environment allows a user to create service models using user interfaces, and does not require low level machine centric and/or platform dependent programming language. Service models are executed as services 130 and are capable of being implemented across an enterprise 100 of technology infrastructures 145, and are executed at each technology infrastructure 145 in a manner that interacts with enterprise infrastructure 140 or other technology infrastructures 145.

The enterprise development infrastructure 135 includes a model schema 105, a model designer 110, a model repository 115, and a model deployer 120, and a runtime framework 125. The model schema 105 defines the modeling language that is used to design and implement service models. The model schema 105 is utilized by the model designer 110, the model repository 115, and the model deployer 120. The model designer 110 creates concrete instances of the model schema 105 that represent service models as designed by an end user of the system. The model repository 115 stores these concrete instances in a version control system designed to version the model information, and to make it available for use by multiple service designers. Thus, for example, a service model (or a part of a service model) can be built, accessed, utilized, and/or edited by different users at the same time. Furthermore, the service model, as well as each element of the service model, can be versioned independently of each other. The model repository 115 also makes these model instances available to the model deployer 120 which converts them into generated applications and services that are executable by the technology infrastructures 145. The model designer 110 is the system component where service models are graphically designed and implemented. The model repository 115 allows teams of users to collaborate on service models and provides version control services as well. The model deployer 120 converts meta data from the service models (from the model designer 110 or the model depository 115) into code and deployment artifacts for the technology infrastructures 145 to employ. It also compiles the service models and distributes them with their runtime framework 125 as executable project package 101. The generated runtime service framework 125 is used by the generated code of a service 130 during the execution of the service 130 at the technology infrastructures 145.

### The Model Schema

FIG. 2 illustrates various components of the model schema 105, according to one embodiment of the invention. A domain 215 is a deployment concept that represents a logical grouping of physical and virtual resources where executable packages 101 will execute on technology infrastructures 145. The domain 215 includes representations of one or more physical servers as well as one or more relational databases. The domain 215 model represents data regarding these resources and is a logical description of those resources that are used when generating an executable project package 101 which is tailored to run in the target environments (e.g., technology infrastructures 145).

A data source 205 is a representation of a relational database system that will be used by a generated software service. The data source 205 includes the type of database, its URL and port information, security etc. A server 210 is a representation of an application server or runtime server where an executable project package 101 can execute in a technology infrastructure 145. The server 210 meta-data includes information about the type of server, the application server version, port configuration, and other meta-data that may be required to tailor the generated software service to run on a particular server of the technology infrastructure 145.

A deploy history 220 is a record of each deployment which includes the meta-data of the domain at the time of each deployment. The deploy history 220 is utilized during the deploy process to ensure that only changed items are deployed or reconfigured and is also utilized to provide a mechanism to restore previous domain deployment configurations. Ensuring that only changed items are deployed helps optimize the model driven environment. The deploy history can also be used to restore previous deployment states from domain models which were previously deployed. A deploy event 255 is a representation of one step or a group of steps that occur during deployment. These deploy events can be viewed outside of the model deployer 120 as a communication mechanism allowing external observers of the deploy to detect the successful completion of deployment steps or their failure.

A service runtime registry or enterprise service bus 240, is a representation of a class of enterprise software that is designed to manage executable project packages 101 at runtime. Runtime registries act as a phone book or directory for enterprise software services and sometimes also offer management and searching capabilities for services and their descriptions and locations. Enterprise service buses normally incorporate the functionality of a runtime registry but also provide an integration capability to incorporate existing enterprise systems into the enterprise service bus. Both technologies provide mechanisms to register and locate software services. These technologies will be referred to in this document as runtime registries. The domain 215 can be configured with one or more service runtime registries 240 of varying types. A project 235 can be bound to one or more service runtime registries 240 in the domain 215. When the project 235 is deployed, the service runtime registry 240 is updated with the location information and other meta-data about the project package 101 that is deployed based on the project 235.

A project deploy 230 is a representation of a project 235 as it is configured to be deployed within a particular domain 215. Each project 235 is made up of service models 245. A project 235 represents a collection of service models 245 that will be deployed together. A project 235 can be thought of as an organizational element that helps to group similar or related service models 245 into one package. A service model 245 represents a collection of meta-data constructs that define the way a service model 245 should behave when executing. Each service model 245 contains one or more logic models 255, data objects 260, GUI root 253, and user interface web models 250 as well as other meta-data concepts used to define software services and their implementations. Each data object 260 from each project 235 is linked to a data store 265. The service models 245 and/or parts of service models 245 can be utilized with other service models 245. Because model driven design, model driven development, and model driven deployment are combined with service oriented architecture, the service models 245 can be verb oriented (i.e., action oriented) rather than noun oriented (i.e., object oriented). By breaking work down into smaller and smaller service models 245, a level of flexibility in programming is provided that allows the combinations and/or orchestrations of the service models 245 and/or parts of service models 245. In addition, the service models 245 and/or parts of service models 245 can be integrated with existing technology assets like databases, existing Java code, and/or existing Web services. Furthermore, one service model 245 and/or part of a service model 245 can call another service model 245 and/or part of a service model 245, thereby allowing a service designer to break up the logic into small, reusable pieces.

A logic model 255 is a model that describes the logical flow of execution for an operation within a service model 245. A logic model 255 defines a set of input parameters, output parameters, variables, and execution steps. The logic model 255 is the visual representation of the execution path(s) for a specific operation within a service model 245. Each logic model 255 contains one or more logic components 275 which simply help to organize the logical flow of execution into smaller more manageable pieces. A logic component 275 is a representation of a set of logic steps 285 which are executed together; Logic components 275 are similar to subroutines in text based languages. A logic step 285 is a representation of a specific set of executable instructions utilized to perform the work of the operation within a logic model 255. Each logic step 285 can be a pluggable entity of a particular type which controls the way that it is configured and customized within the model designer 110 and eventually controls the type of code that is generated by the model deployer 120.

A data object 260 is a representation of a data model in that it describes a combination of fields of specific names and types, and it further defines relationships between other data objects 260. Data objects 260 are analogous to a Complex Type in XML and many programming languages. A data store 265 is a representation of a logical grouping of instances of a certain type of data object 280. For example, if there is a data object 260 called Companies, there may be a data store 265 for South American companies and another for African Companies. A data store 265 represents a logical container of runtime data. An exception 270 is a representation of some type or classification of error that may occur while the project package 101 is operating. Users may define their own types of exceptions 270 to report and acknowledge specific system states or errors.

A web model 250 is a variant of a logic model which represents a set of execution steps or logic steps but that is inherently designed to drive a user interface and the integration of the user interface with execution logic and the other portions of a service model 245.

A GUI root 253 provides the capabilities to define Rich Internet Application and service which can be created completely within a web model designer 325 (discussed later) or on its own and which can include both synchronous and asynchronous page loading and server communication styles while further providing drag and drop creation and configuration of dynamic html and web based content. Each GUI root 253 also can also contain any number of GUI. Pages 263 that define the user interface to present. Each GUI root 253 also can also contain any number of GUI resources 254 that can be embedded or utilized in each GUI page 263, such as images, style sheets, flash movies, or any number of user interface constructs.

A web service 290 is a representation of a specific instance of a web model which is usually a piece of software logic that is available at a specific location and which performs some function when invoked remotely through some standard invocation protocol. Each web service 290 contains one or more web service methods 291. A web service method 291 is a representation of a specific operation within a web service 290 and includes the definition of the inputs and outputs of the web service 290 operation as well as its name.

A Java service 293 is a representation of a collection of Java classes 295 which may be incorporated into the Java service 293. Each Java service 293 contains one or more Java classes 295 each of which contain one or more Java methods 297. A Java method 297 is a representation of a specific operation within a Java class 295 which is defined by its name, its set of inputs and its output type.

### The Model Designer

The model designer 110 is made up of several systems that deliver an environment capable of completely modeling services and applications. The model designer 110 is the user interface used to visually create instances of the model schema 105. The model designer 110 can provide a virtual file system for model storage as well as various other services utilized during the design and implementation of service models. Entities in the model schema can have their own “designer” which is responsible for creating a user interface suitable for configuring that type of entity. The system provides a pluggable architecture so that new entity “designers” may be configured and integrated within the system.

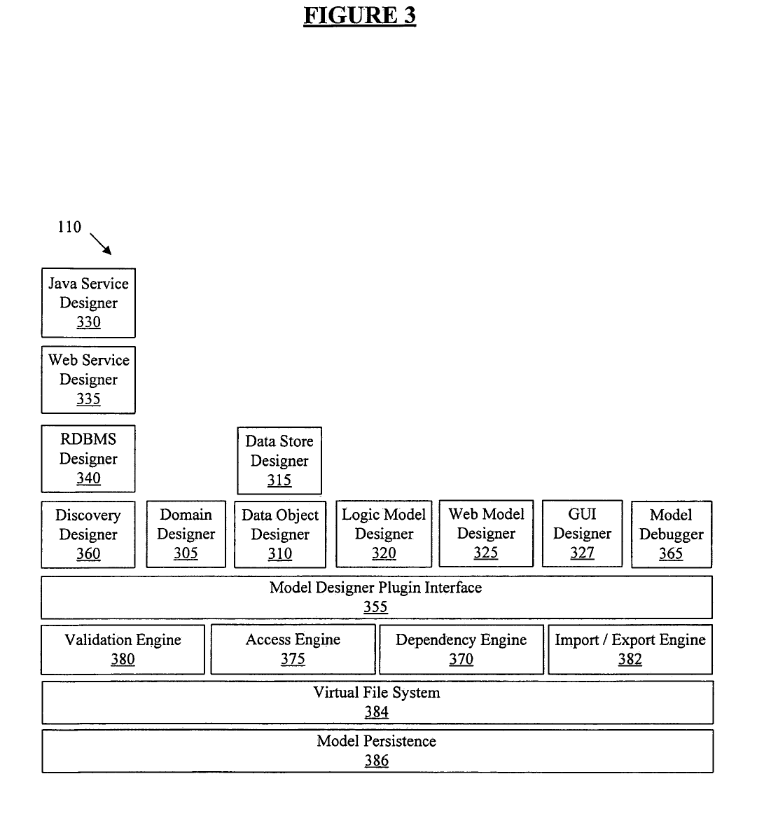

FIG. 3 illustrates the model designer 110, according to one embodiment of the invention. The domain designer 305, which will be described in more detail below, provides an interface where various deployment domains can be modeled including collections of servers, data sources, and projects representing a logical or physical software execution center providing the ability to dynamically bind the virtual service design with the physical software implementation strategy. The data object designer 310, which will be described in more detail below, is used to visually design one or more data objects each of which represents the meta data for a complex type that would be used within the service model. Data objects normally represent tangible entities within the system design like companies or employees and have fields and relationships with each other. The data object designer 310 is capable of creating and describing any data model. The data store designer 315, which will be described in more detail below, is used to visually design data stores which are logical definitions of storage areas for a certain type of data objects. Each data object can have one or more data stores. The data store abstraction is used within the logic model designer 320 and the web model designer 325 to interact with the underlying persistence framework of the project package 101 when it is deployed. The logic model designer 320, which will be described in more detail below, provides the interface needed to design logic models in a completely graphical environment. Within the logic model designer 320 users can design service operations and their implementation details. The web model designer 325, which will be described in more detail below, can serve as the variable container, interface flow controller and logic layer for all user interfaces created within the GUI designer 327. The GUI designer 327 provides the capabilities to define a Graphical User Interface page, screen or portion of a page or screen and can be created completely within the web model designer 320 or can be created separately. The GUI designer 327 can include both synchronous and asynchronous page loading and server communication styles while further providing drag and drop creation and configuration of dynamic html and web based content in a graphical interface. The web model designer 325 can incorporate a GUI designer 327. The GUI designer 327 can also be created separately. Each of the designers is built to plug into the model designer plugin interface 355, which acts as an extension point for the addition of new modeling concepts and designers. The model designer plugin interface 355 is responsible for creating and managing the list of model designers that are plugged into the model designer environment. The modeling environment and the deployment are capable of being extended and/or customized. The model can be extended and/or customized by the model designer plugin interface 355. The discovery designer 360 is responsible for managing a set of designers that are tailored for the discovery and integration of external technologies and enterprise infrastructures. The discovery designer 360 manages the relational database management system (RDBMS) designer 340, the web service designer 335 and the Java service designer 330. The RDBMS designer 340 is used to connect to existing enterprise data sources and to provide an user interface that allows a service designer to incorporate the data from that database into their service. This is accomplished by inspecting the meta data that is provided by the database including the table definitions and field definitions within each table, and creating data objects within the service model which represent those tables. These data objects are later tailored during the deployment step to automatically synchronize with the data source providing a sophisticated integration with existing relational data within the modeling environment. The Java service designer (330) provides a similar interface but is responsible for discovering existing Java classes and methods and importing and incorporating those classes and methods into the service model. The Java service designer enables the use of existing Java code within the executing software service. The web service designer 335 provides the same functionality for web services allowing the service designer to discover and incorporate existing web services by incorporating the definition of that web service as it is described by a WSDL file. WSDL stands for web service definition language and is an XML standard for describing a web service. The web service designer utilizes the WSDL document to build a linkage to the web service for use in the generated software service. This allows the linkage of existing software services to new software services through the discovery engine. Finally, existing web services can be located in many ways but will often be located by searching an enterprise service bus or runtime registry. The discovery designer 360 is responsible for receiving the meta data related to the item(s) being discovered as detailed above, and converting that meta data into models which represent the external integration points, including web services, Java services and relational databases. In one embodiment, a model debugger 365 can be responsible for translating debug information from an executing software service back into the software model so that the steps of execution, variable values, and other standard debug information can be reviewed within the model designer as an aid to finding and correcting logical errors in the model. The dependency engine 370 (see 450) is responsible for providing and maintaining a list of dependencies between various components in the domain model and service models. The dependency engine provides the capability to deploy only changed objects and their dependencies, as well as providing a visual representation of dependencies to users of the model designer 110, including the domain designer 305. The model access engine 375 is responsible for controlling access to the service model and domain model. This layer grants or prohibits access to modifications to models based on password protection which can be added to the service model to control modifications to the model, even after it has been distributed to a 3^{rd} party. In one embodiment, the locking and access layer can also enforce the security of the model if it is created and managed within the model repository 115. The validation engine 380 (see 455) is responsible for validating the domain model and the service model to ensure that there are no errors or issues in the design or implementation of the model that would result in errors or issues in generated software services 130. In one embodiment, the model is XML-based (i.e., anyone can access it). In another embodiment, the model can be stored in a proprietary format and can use an import/export engine 382. The import/export engine 382 can be responsible for moving the service model(s) in and out of the platform as XML. This capability allows the service models to be stored and managed outside the model designer so that they can be distributed or archived. The virtual file system 384 can act as a linkage between the model designer and the persistence engine that is used to store the service model and the domain model. The virtual file system can act like a file system but can be extended to persist models to a relational database or other form of persistence. The model persistence layer 386 can be responsible for actually storing and retrieving the service models and domain models and making them available to the virtual file system. The model persistence layer can be implemented as either a database or operating system file system.

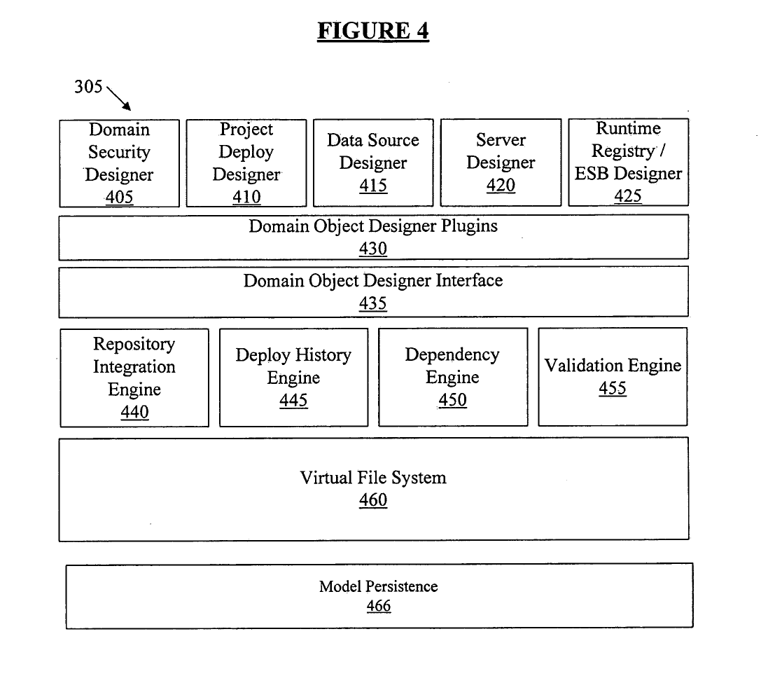

Domain Designer 305. FIG. 4 illustrates details of the domain designer 305, according to one embodiment of the invention. The domain designer 305 provides a visual modeling environment for creating and managing instances of the domain object from the model schema definition 105 and provides a generic designer system which allows new domain object types to be added to the system and configured and managed within the domain designer 305. The major modeling concepts for each domain are security, projects, data sources, service registry and servers. Each domain defined within the domain designer 305 represents a physical or logical set of systems where project packages 101 may run and the resources that are bound to the applications and services that are generated to run within a domain. The domain security designer 405 provides an interface for declaring the details of the security system that is utilized within the deploy domain. When the domain is deployed, each application and service will be configured to interact with the host security systems for role based authentication. The project deploy designer 410 provides an interface for specifying which projects and services should be deployed within a given domain. Each project is bound to a specific server and each of the data objects are linked to a specific data source. The project deploy designer 410 captures information about where the model deployer 120 should retrieve the model data from and also contains information about the way that the project should be deployed. The data source designer 415 allows for the creation of one or more definitions of physical data sources or databases that will be utilized by projects and services deployed within a specific domain. The data source configuration includes database connection information as well as the database type, driver etc. Each data source can be bound within the domain to one or more projects and services allowing the data objects defined in those projects to be late bound to a particular data source. The server designer 420 is used to create and configure representations of physical machines that are capable of receiving the deployed projects and services from the model deployer 120 and making them available for execution. The server designer 420 captures information about the physical machine, the type of application server and infrastructure available on the machine, and other pieces of information needed to tailor the generated software services 130 for the deployed environment. The runtime registry/enterprise service bus designer 425 is used to create a reference to a runtime registry or enterprise service bus that should be notified of the services being deployed. The runtime registry/enterprise service bus designer 425 has an interface which accepts information concerning the specific type of registry, the service cataloging specification to utilize, as well as the projects to publish to a particular registry or enterprise service bus.

The domain object designer interface 435 provides an extension point for the creation and addition of new domain concepts which are peers to data source and project deploy. The domain object designer plugins 430 are the set of domain object designers that have been incorporated within the modeling environment through the domain object designer interface 435. The model can be extended and/or customized by the domain object designer interface 355. The repository integration engine 440 provides an extension point for the domain designer 305 to integrate with version control systems to retrieve model data to be deployed. The repository integration engine 440 interacts directly with the model repository 115. The model can be extended and/or customized by the repository integration engine 440. The deploy history engine 445 is responsible for providing and maintaining a record of each deployment which includes the information from the domain which would be needed to reconstitute any previously deployed configuration. The dependency engine 450 is responsible for providing and maintaining a list of dependencies between various components in the domain model and service models. The dependency engine provides the capability to deploy only changed objects and their dependencies, as well as providing a visual representation of dependencies to users of the domain designer 305. The validation engine 455 is responsible for validating the domain model and the service model to ensure that there are no errors or issues in the design or implementation of the model that would result in errors or issues in generated software services 130. The virtual file system 460 acts as a linkage between the model designer and the persistence engine that is used to store the service model and the domain model. The virtual file system acts like a file system but can be extended to persist models to a relational database or other form of persistence. The model persistence layer 466 is responsible for actually storing and retrieving the service models and domain models and making them available to the virtual file system. The model persistence layer can be implemented as either a database or operating system file system.

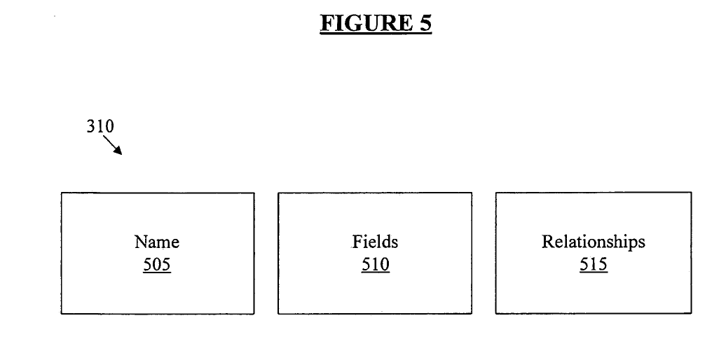

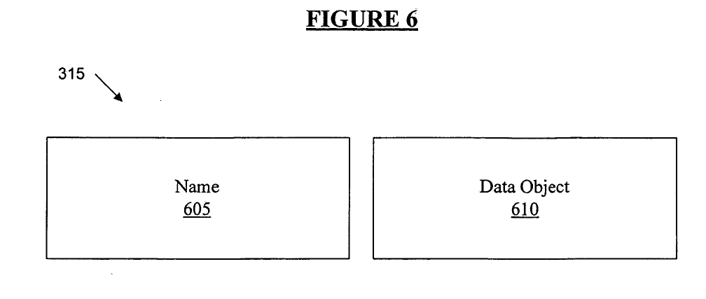

Data Object Designer 310. FIG. 5 illustrates details of the data object designer 310, according to one embodiment of the invention. The data object designer 310 is used to declare the meta-data for a data object which represents the complex type definitions within the modeling syntax of the system. Each data object is declared as having one name 505, a collection of fields 510 each with names and various types, as well as a set of relationships 515 between itself and other data objects. Each relationship has a name on both sides of the relationship.

Data Store Designer 315. FIG. 6 illustrates details of the data store designer 315, according to one embodiment of the invention. The data store designer 315 is used to declare and define a data store which is a logical storage location for a particular type of data object. Each data object may have one or more data store. The data store is used within the logic model and web model to interact with the underlying persistence mechanisms that are late bound to the project and service during the deploy phase. The data store therefore is an layer of abstraction between the executing model and its physical system underpinnings. The data store includes a name 605, and a data object 610.

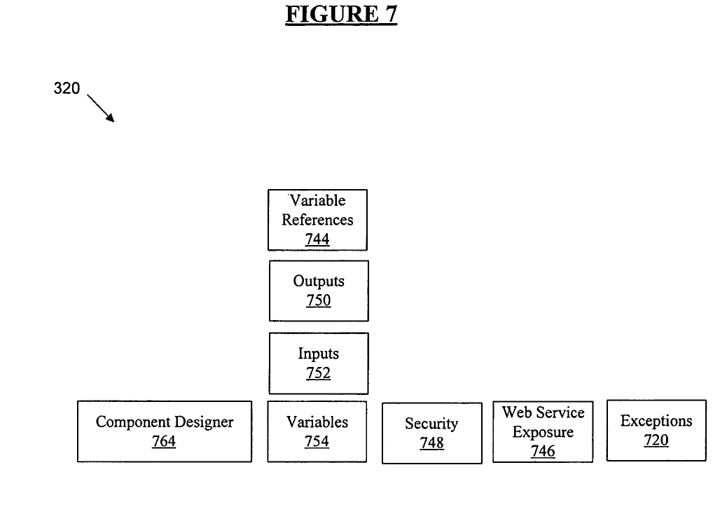

Logic Model Designer 320. FIG. 7 illustrates details of the logic model designer 320, according to one embodiment of the invention. The logic model designer 320 contains the meta-data needed to model business logic within a service. Each logic model designer 320 can have one or more component designers 764, which are described in more detail below. Each logic model designer 320 has attributes which are general to the logic model and all of the component designers 764 it contains. Attributes includes variables 754, inputs 752, outputs 750, security 748, web service exposure 746, exceptions 720 and variable references 744. Variables 754 are objects or values that are utilized within the logic model to store information in a formulated way. Variables 754 may be standard raw types such as “Integer” or “Decimal” or “Text” or “Image” or “Date” or they may also be data objects or collections of data objects. A collection is a holder of more than one item of the same type. It is analogous to an array. Inputs 752 are variables which originate from the invoker of the logic model representing those values that can be passed to the logic model at execution time as a running software service. Outputs 750 are the variables which will be returned to the invoker of the logic model representing the response: to the logic model execution. Security 748 is the configuration of whether or not the executors of the logic model should be authenticated within the technology infrastructure which is hosting the executing software service. Exceptions 720 are the possible errors which the logic model designer 320 may encounter or throw to its caller when it executes. Web service exposure 746 can control whether or not the logic model should be published as an operation of a web service. The variable references 744 can show which components designers 764 use or reference any given variable 754, input 752 or output 750.

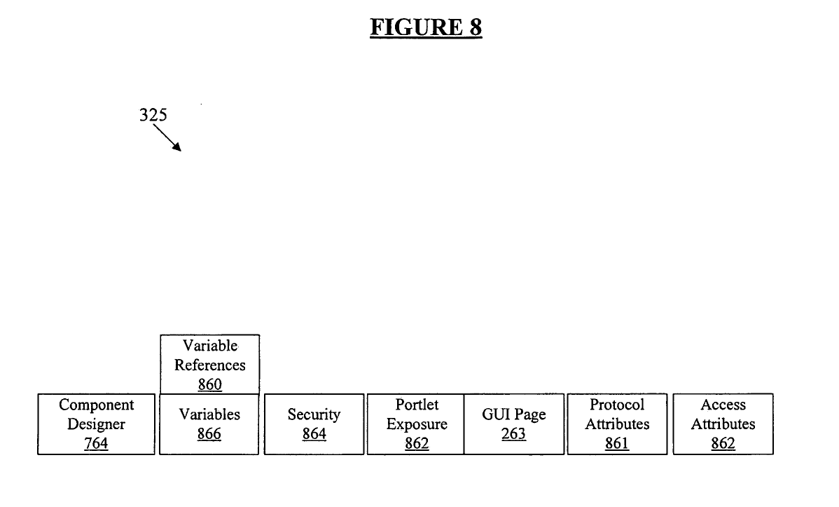

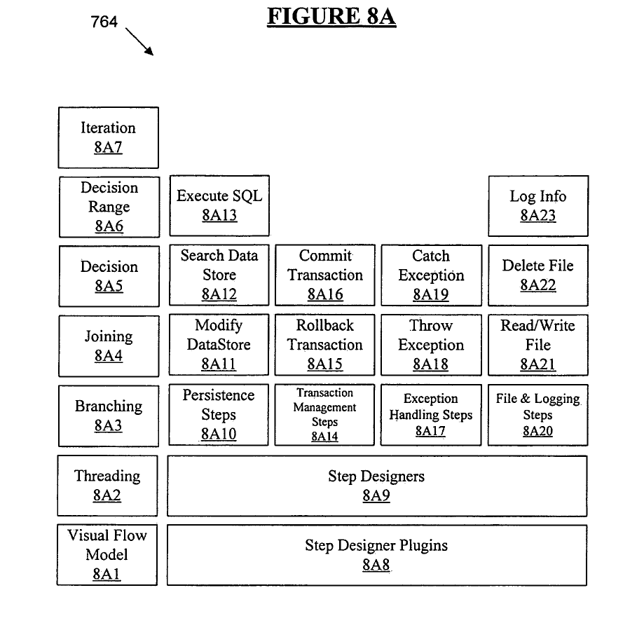

Web Model Designer 325. FIG. 8 illustrates elements of a web model designer 325, according to one embodiment of the invention. A web model is a variant of a logic model which represents one or more component designers 764 that are inherently designed to drive a user interface and the integration of the user interface with execution logic and the other portions of a software service model. Each web model designer 325 can have attributes which are general to the web model and all of the component designers 764 it contains, this includes variables 866, security 864, portlet exposure 862, default GUI page 263 and variable references 860, protocol attributes 861, and access attributes 862. When using protocol attributes, the user can configure the web model designer to be accessed via http, https, or any other standard protocol type. If the user selects https for the protocol all access to GUI pages will be displayed securely in a web browser using encryption. The user can also optionally configure the web model to be published as a WSRP portlet. The user can also indicate that a web model cannot be directly accessed. In this case, web pages could be included in other web pages that do allow direct access. The user can also indicate that a web model requires authentication.

Every web model designer 325 can have one GUI page 263 designated as the default. After the web model is deployed, an end user loads the web model by entering its unique URL into a browser and the server loads the default GUI page 263. Variables 866 are objects or values that are utilized within the logic model to store information in a formulated way. Variables 866 may be standard raw types like “Integer” or “Decimal” or “Text” or “Image” or “Date” or they may also be data objects or collections of data objects. A collection is a holder of more than one item of the same type. It is analogous to an array. Security 864 is the configuration of whether executors of the web model should be authenticated within the technology infrastructure which is hosting the executing software service. The variable references 860 can show which component designers 764 use or reference any given variable 866. Portlet exposure 862 can control whether or not the web model should be published using the Web Service Remote Portlet (WSRP) or Java Service Request (JSR) 168 specification for embedding that web model within a portal.

Component Designer 764. FIG. 8A illustrates elements of a component designer 764, according to one embodiment of the invention. The component designer 764 can be responsible for providing the user interface to model business logic. Each logic model designer 320 and web model designer 325 can have one or more component designers 764 which are utilized to break the visual model up into smaller discrete representations. The step designer plugin(s) 8A8 can represent the pluggable layer of extension where new step types and their “designers” can be plugged into the system. Thus, the model can be extended and/or customized by the step designer plugins 8A8. Each step type can have a step designer 8A9 which is responsible for that step type's visual configuration and the definition of the code that will be output from the step.

Each component designer 764 can have a visual model flow 8A1 which is a visual composition of the logic and execution paths for a given component. The visual flow model can create a picture of the execution logic and provide a canvas for each logic step to be represented and configured. The visual model flow can incorporate capabilities such as threading 8A2 by allowing multiple lines of execution to be branched (branching 8A3) from a single logic step. When branches of execution converge they are joined (joining 8A4) using logical operators like (and, OR and XOR) which represent logical operators which control the execution of each thread of logic. If two branches join with an AND join step, then the logic execution will not be complete until both threads reach the join step. If the branches join with an OR join step, then the logic execution will continue when either thread reaches the join step. When an XOR step is used, the logic will continue as soon as one thread reaches the join step, and the other thread will stop immediately. Decision steps (8A5) can represent points in the logical execution where some set of conditions can be checked to determine whether to follow one of two paths in the logical execution. A decision range (8A6) can represent multiple paths each of which may be followed if a given set of conditions are met. Iteration (8A7) is the flow control concept that allows each element of a “collection” to be passed through a set of logic steps. In one embodiment, an execute SQL, a search data store, a modify data store, a delete file, a read/write file, a commit transaction, a rollback transaction, a throw exception, and a catch exception cal also be utilized. These components are described below with respect to FIG. 8A. In one embodiment, the component designer 764 or the web model designer 325 can dictate the next page to display. In another embodiment, the web page dictates the next page to display. In the embodiment where the component designer 320 dictates the next page to display, each component can have a setting for a next component. The next component is the component that will be loaded after the current one. This allows a user to create logical flows in their user interfaces; that is, to designate one part of a user interface to follow another part. Every web model can have one component designated as the default component. After the web model is deployed, an end user can load the web model by entering its unique URL into a browser and the server can load the default component.

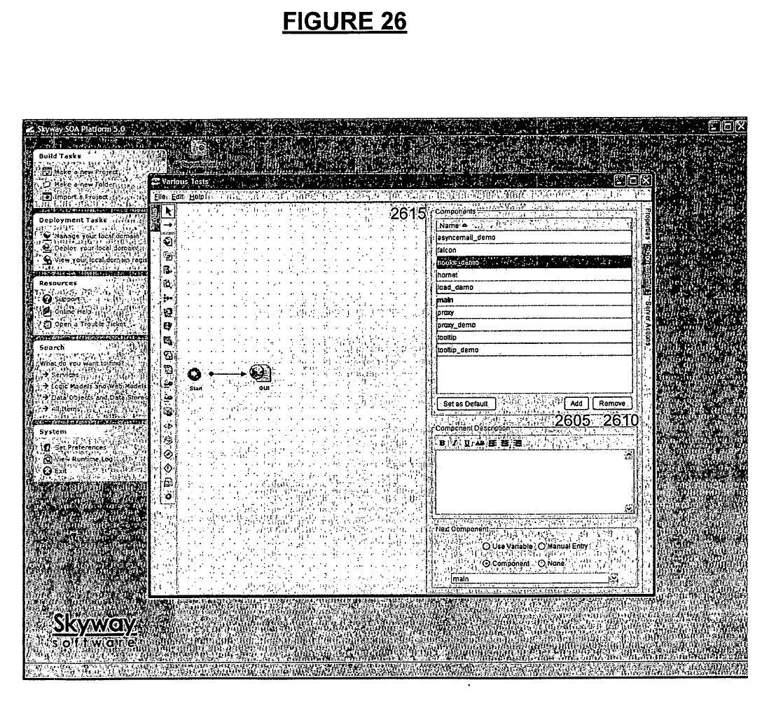

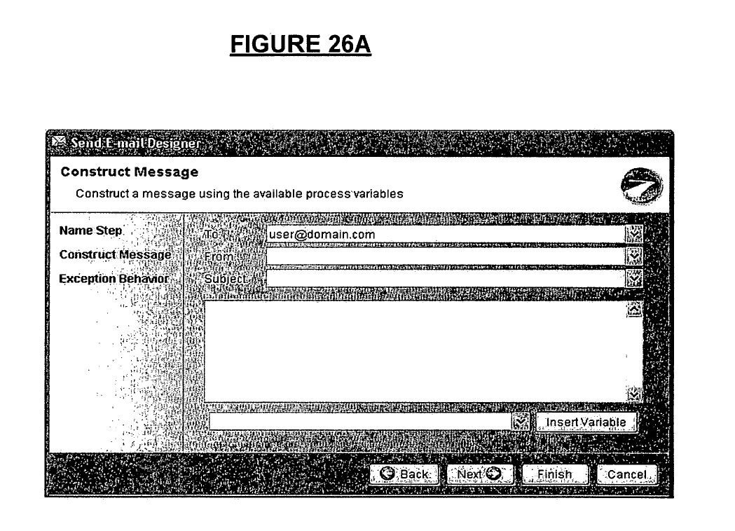

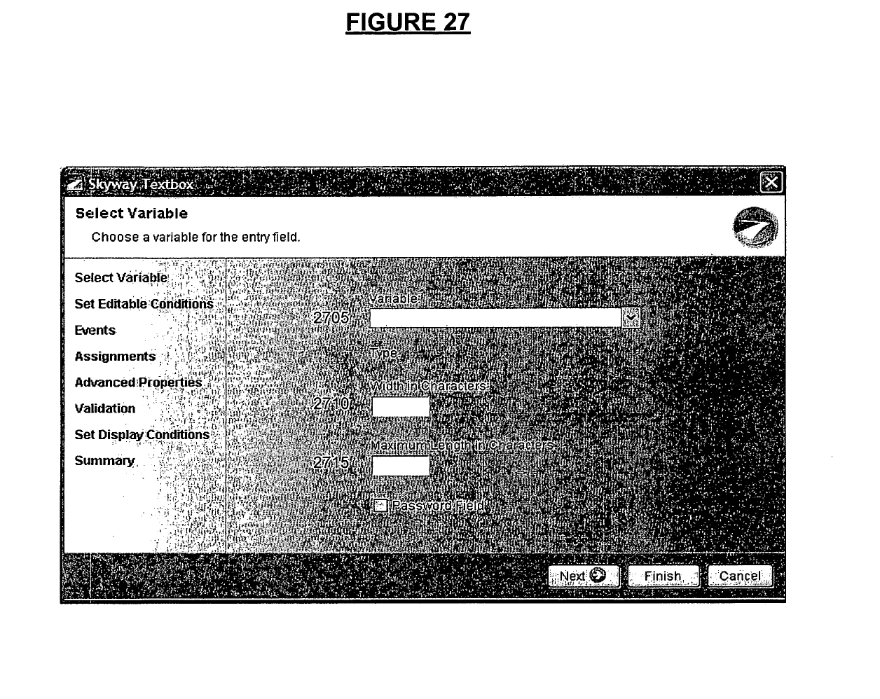

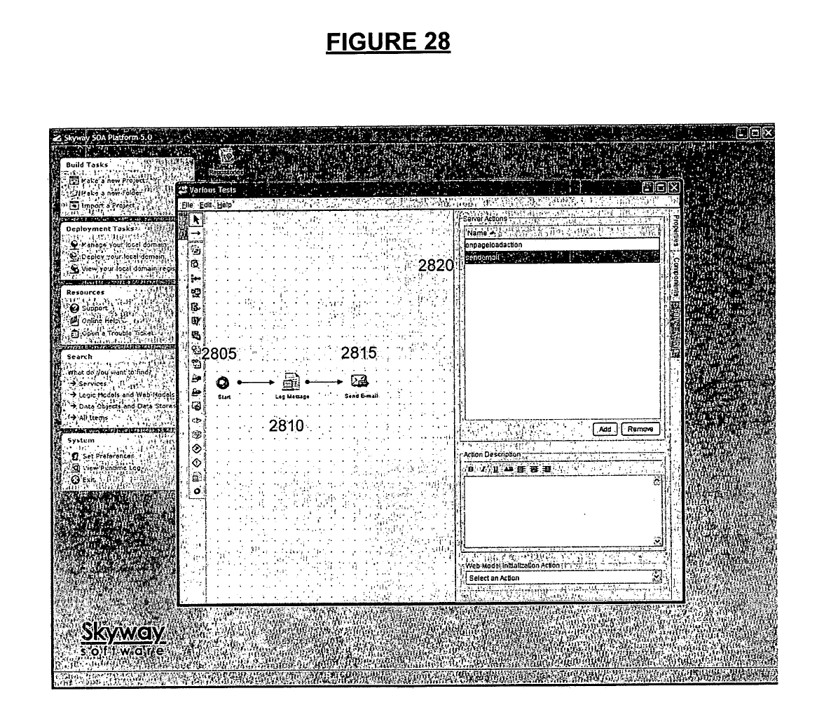

In an additional embodiment, the web model designer can dictate the next page to display. The web model designer can provide an interface that allows a user to build and organize components to form a web application. An example of such a user interface is set forth in FIG. 26. As illustrated in FIG. 26, users can add 2605 and remove 2610 steps to a component designer or GUI designer and wizards can be provided that enable the user to configure these steps without writing any codes. For example, as illustrated in FIG. 26A, a user can add a “send email” step to a component that will sent an email when executed. A wizard for the “send email” step can provide entry fields for the user to designate the email recipient, subject and text of the message. Each step type within the component designer can be optionally configured through a wizard driven interface, through direct code manipulation, or through proporting manipulation. The flow of execution within a component designer is determined by the wiring of steps together to perform complex business logic. Such flows can be connected in through the GUI designer 327 to a web page for invocation before and/or after the display of the page to create complex web flows.

The system is preconfigured with many step types, including the following: persistence steps 8A10, transaction management steps 8A14, exception handling steps 8A17, and file and logging steps 8A20. The logic steps that can be configured are extendable allowing new step types to be added to the system and configured within the model designer. Together, the logic steps represent the specific operations that can be taken within a logic model or a web model. Complete software services and applications are created by combining and configuring the various step types within the component designer 764. The persistence steps 8A10 include modify data store 8A11, which can be configured to add or remove data objects from data stores; search data store 8A12, which can be configured to retrieve data objects from data stores using a visual query syntax or a structured query language; and execute SQL 8A13, which can execute structured query language statements against a data source and map the results to data objects, as well as any other step type that may interact with a relational database. The persistence steps 8A10 are designed to represent the action of retrieving or storing data and can be visually configured to perform any database operation. The transaction management steps 8A14 include commit transaction 8A16 and rollback transaction 8A15. Each step is implemented by a step designer 8A9 which provides a graphical configuration designer for the step. The step designers 8A9 enforce transactional consistency within the flow of the logic model and further enforces implied transactional boundaries when logical flows branch into parallel paths. The placement of the commit step specifies the point in the logical flow where the currently executing transaction should be committed. When the commit operation occurs, all data modified within the transaction boundary will be persisted to the underlying database. If there are any issues or errors the transaction will be rolled back and none of the changes made within the current transaction execution will be saved. A rollback transaction step 8A15 can be inserted at any point in the logic model's execution path and specifies that when that step is reached, that the current transaction should be aborted and all data modifications should be ignored by the underlying database. The exception handling steps 8A17 includes the catch exception step 8A19 and the throw exception step 8A18. The exception handling is model-based. Thus, the logic can be designed so that how an exception is executed during runtime is based on the logic. The catch exception step 8A19 can be configured to receive notification of one or many types of exceptions including user defined exceptions and can then direct the flow of the component designer 764 execution based on the type of exception that has been encountered. The catch exception step 8A19 can also be configured to record the information about the exception including the path to the step that threw the exception and the detail of the exception into one or more variables. The throw exception step 8A18 can be configured to throw one type of exception which may be a user defined exception and can dynamically bind information from the executing component designer 764 into the exception which is thrown. The file and logging steps 8A20 include the read/write file step 8A21, delete file step 8A22, and log info step 8A23. The file and logging steps 8A20 can be configured to read and write information from the file system where the generated software service 130 is running and can be configured to utilize the file information within the component designer 764. The log info step 8A23 can be configured so that the service integrates with an existing logging system (e.g., the enterprise software and/or other technology infrastructures within the enterprise) and can log execution information and variable information through the underlying logging system. The log info step 8A23 can be configured to execute based on variable data from within the component designer 764 or through standard preset logging levels.

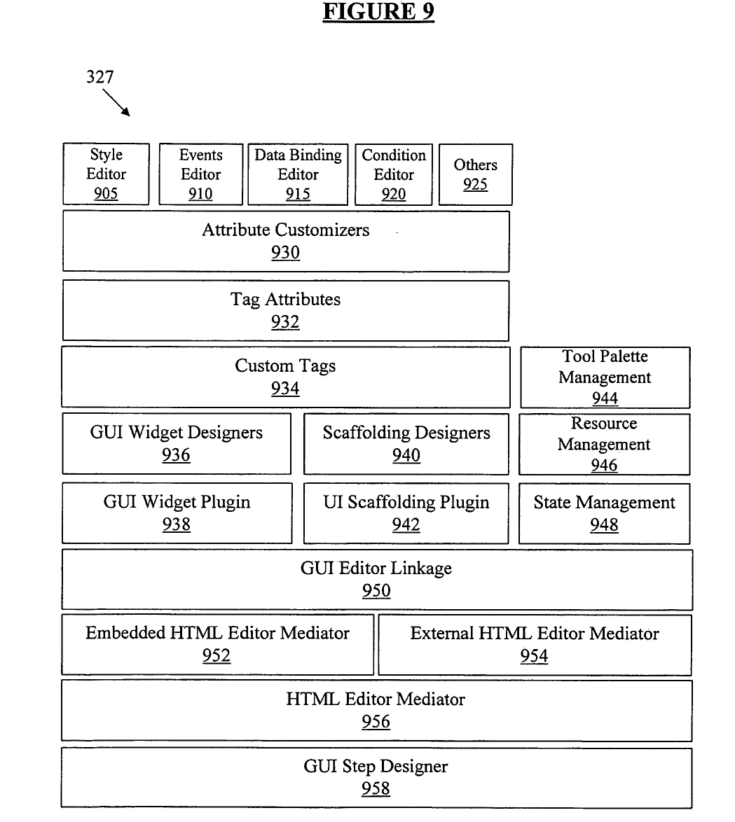

GUI Designer 327. FIG. 9 illustrates elements of a GUI designer 327, according to one embodiment of the invention. The GUI Designer 327 enables the creation and modification of the user interface for a web application. In one embodiment, this is a single web page. In another embodiment, this can also be a small region of a web page. Web pages are made up of many visual elements, such as images, forms, hyperlinks and buttons. These elements are sometimes called web controls and they are made up of attributes and behaviors. For example, a button has a text label. This is an attribute. And a button usually does something when it is clicked. This is a behavior. When building a web application, a user traditionally has to code these attributes and behaviors using programming and markup languages like Java and HTML. But as with the steps in a component, the web model designer 325 can provide wizards that allow users to create these elements without any manual coding. Users can configure both the attributes and the behaviors of these elements using these wizards, which are accessed from inside the web page editor.

The style editor 905 is an editor that lets users select style attributes such as text color and font style. The events editor 910 is an editor that lets users configure what should happen when certain events occur on their web controls. For example, a user could configure a button click to send an email. The data binding editor 915 is an editor that lets users configure assignments that are processed when certain events occur on their web controls. For example, a user could configure a button click to set a variable called color to ‘red.’ The condition editor 920 is an editor that lets users configure conditions that must be met in order to display a web control. For example, a user could configure a button to display only when a variable called Show Button is set to true. The others editors 925 are additional editors which are pluggable to make configuration easier. For example, if a new tag is added that contains an attribute that requires constrained data, a new editor could be plugged into the framework to allow users to easily configure that attribute. The attribute customizers 930 are simple UI panels (whereas an editor could be very complex) that allow configuration of a specific attribute of a tag. For example, a text tag has a size attribute that controls how big the text box is on the web page. Thus, a user can configure the size using an attribute customizer 930. The tag attributes 932 are attributes of a tag. Different tags have different attributes that describe the tag. For example, a text tag has a size attribute that controls how big the text field is on a web page. The custom tags 934 are specific markup strings that can be inserted into a web page that will trigger certain procedures to be executed when the page is being processed by the server before sending it to a web browser client. There are two points of extension in this layer of the model designer. The GUI widget plugin 938 provides an extension point where new custom tags 934 can be incorporated into the design environment. Thus, the model can be extended and/or customized by the GUI widget plugin 938. Each custom tag 934 has a corresponding GUI widget designer 936. A GUI widget designer 936 is a user interface component used to configure a particular custom tag 934. Any new tag that is added may have a custom GUI widget designer 936 and all GUI widget designers are integrated through the GUI widget plugin 938. The other point of extension is the UI scaffolding plugin 942 which is similar to the GUI widget plugin 938 but it is designed to provide an integration point for adding a new scaffolding designer 940. Thus, the model can be extended and/or customized by the UI scaffolding plugin 942. A scaffolding designer 940 is a user interface for designing a set of custom tags 934 at the same time. Each scaffolding element represents a collection of tags put together to achieve a specific web user interface effect. For example, a scaffolding designer 940 may walk a service modeler through the configuration of a web form to edit a variable in a logic model. When the scaffolding designer 940 is complete, rather than emitting one custom tag 934 into the html page, it can emit all of the tags needed to accomplish this composite task. The entire scaffolding infrastructure is designed to allow for the creation of complex web content using custom designers while still allowing each custom tag to later be customized individually. There are many packaged tags, such as button tags and text field tags. The tool palette management 944 is a toolbar with buttons that allows users to insert custom tags into their document. Each button corresponds to a custom tag and clicking the button simply inserts an unconfigured tag into the user's document. To configure the tag with attribute customizers and editors, a user simply double clicks on the tag once it has been dropped into their document. The resource management 946 is a web page containing many resources such as images and movies. The resource manager lets a user add resources to a project. These resources are then available to the user when they configure certain custom tags, such as an image tag. The state management 948 keeps track of open editor sessions and windows. The GUI Editor Linkage 950 is a technical integration piece of the architecture that attaches to the HTML editor and allows the model designer to control it. Different HTML editors require different linkages. This allows for different HTML editors to be used within the model designer 110 on a configurable basis.

In one embodiment, the GUI editor is pluggable, In another embodiment, the GUI editor is not pluggable. In this case, an editor mediator can be used. An embedded HTML editor mediator 952 is a mediator for the embedded HTML editor and brokers system level messages between the model designer and the embedded HTML editor. The external HTML editor mediator 954 is a mediator for the external HTML editor and brokers system level messages between the model designer and an external HTML editor. The HTML editor mediator 956 is how the model designer talks to an HTML editor. The GUI step designer 958 is a designer, or wizard, that allows a user to configure a HTML page that is part of a generated application.

Within the GUI designer 327, wizards are provided for a number of web controls, including forms, labels, iterators, hyperlinks, text fields, buttons, checkboxes and layers. Wizards allow users to configure the attributes of controls on a web page such as buttons and hyperlinks. Wizards also allow users to configure behaviors, or actions, associated with these controls. Users can configure a set of actions and attach those actions to an event on a control. For example, a button or click event can be configured to send an email or load content into a web page. FIG. 27 illustrates an example of a wizard. A variable 2705 can be selected. As explained above, variables are objects or values that are utilized within the web model to store information in a formatted way. A character width 2710 and character maximum length 2715 can be designated. In addition, a password field 2720 can be designated. If the password checkbox is checked, the input field that is created in the HTML form will have its “password” attribute set to true which will cause the Web Browser to obfuscate the user input usually with “*” or some other character.

User interfaces are also provided to configure a variety of actions. There are two that can enhance the functionality users can build into their web applications without doing manual coding: the load component action and the invoke server action. The load component action loads a component into a layer on a web page without reloading the page. A layer can be any element on a web page that has content in it. When a load component action executes, a request is sent by the browser to the server for a component's content. The server loads and executes the steps in the requested component and then returns the user interface defined in the GUI step of that component. Once the browser receives this content, it inserts that content into the designated layer. The load component action provides a way for the browser to change content and update very specific regions of a web page without reloading the entire page. In addition, the load component action does not require a programmer to write any code (e.g., JavaScript, HTML, Java).

The invoke server action invokes a set of logic steps on the server called a server action. Since actions are behaviors that get attached to elements on a web page, this allows users to visually configure an element on a web page to execute functionality on the server. A server action is a set of steps. Server actions do not have GUI steps or next components. A server action is invoked by configuring a web control to invoke it. For example, a user can configure a button on a web page to invoke a server action. When that button is pressed, a request is sent to the server for the server action to be executed. FIG. 28 illustrates an example of a server action within the server action designer 854. The server action designer is a specialized component designer which is responsible for configuring a set of logic steps which can be linked to a user interface element within the GUI designer 327. In 2820, different server actions can be created. In this example, the send email action is chosen. In 2805, the process starts. In 2810, a log message step is chosen. In 2815, a send email step is chosen which can be configured to send an email. Server actions can be invoked asynchronously or synchronously. If a server action is invoked asynchronously, the page that triggers its invocation is not reloaded. If a server action is invoked synchronously, the page that triggers its invocation is reloaded after the server action executes. Users can create server actions in the same way they create components in the web model designer.

A web model can contain any number of variables. These variables can be populated with data using steps in a component or server action. Users can also create web forms in their web pages that will populate web model variables With user input. If a user wants their web pages to interact with web model variables, they must use custom controls. For example, if a web model has a text variable called name and the user wants to display that value on a web page, the custom control should be used. The user can drop this control onto their page using the custom control toolbar and then configure the label to display the value of name.

### The Model Repository

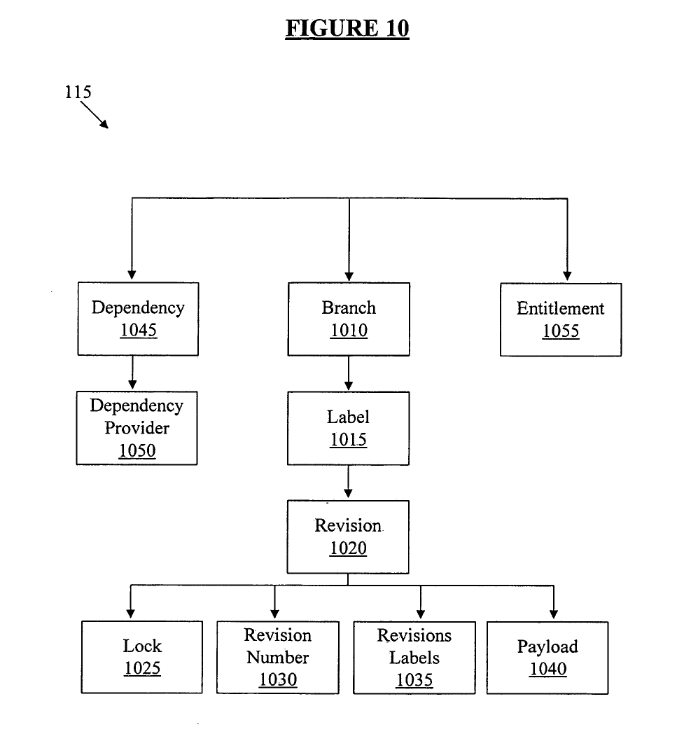

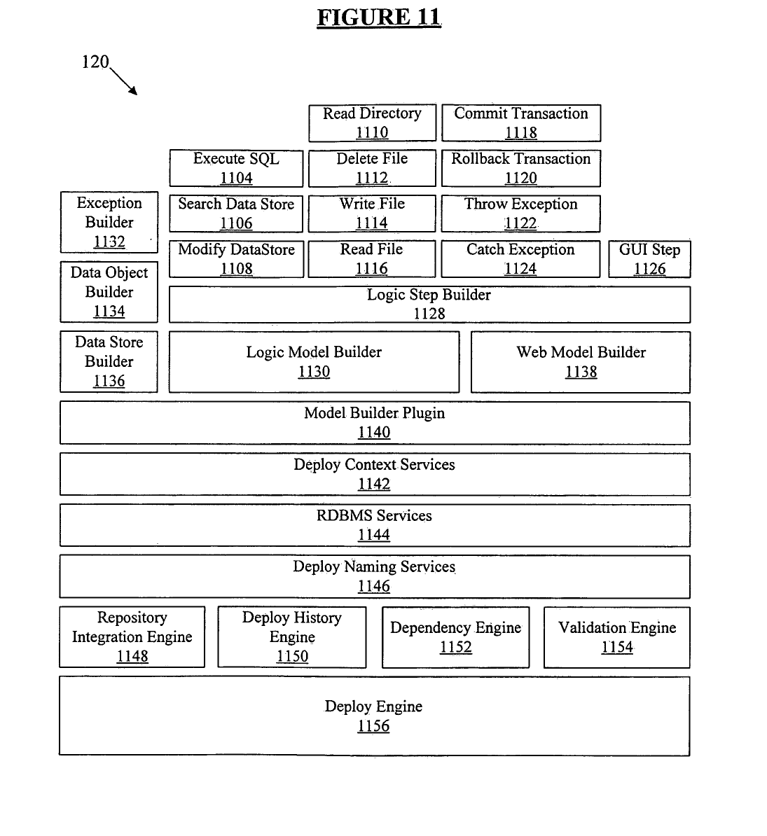

FIG. 10 sets forth the details of the model repository 115, according to one embodiment of the invention. The model repository 115 acts as a model based source control facility for instances of the model schema 105 that are created and managed within the model designer 110. The model repository 115 also acts as a source of information for the model deployer 120 which synchronizes with the model repository 115 prior to a model being deployed. A branch 1010 represents a path of development which can contain many revisions of many objects which are managed and maintained separately from some other path of development. Each path is referred to as a branch 1010. A label 1015 is a name for a collection of specific revisions of one or more objects that exists on one branch 1010. The purpose of a label 1015 is to provide a logic name to a set of revisions usually representing some state of development that should be easily recalled. For example, someone may create a label called “FINAL RELEASE” representing the model schema 105 that were packaged and distributed as the final build. A revision 1020 represents a specific version of an entity. Each revision 1020 has a revision number 1030 and can be associated with one or more revision labels 1035 and can exist on only one branch 1010. Items contained within the model repository may have dependencies on each other and so the model repository includes a dependency engine 450. The dependency engine 450 is responsible for providing and maintaining a list of dependencies between various components in the service models contained within the model repository. A dependency 1045 is a logical representation of a linkage between any two items. A dependency provider 1050 is simply any item in the repository which is involved in a dependency relationship with another item. The model repository provides a security system which, allows named users to be granted or revoked access to items within the repository. This is managed through a set of entitlements 1055. A lock 1025 can be placed on any item within the model repository which will prevent concurrent modifications to the same item by different users of the model repository. The payload 1040 is the actual content or model that is stored with each revision.

### Model Deployer

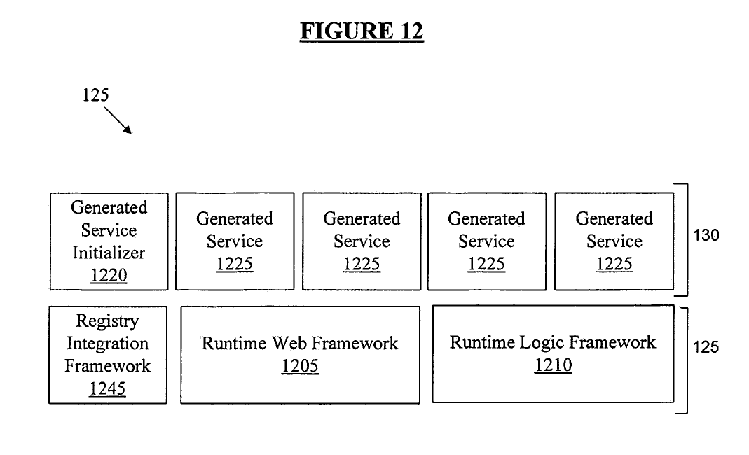

FIG. 11 sets forth the details of a model deployer 120, according to one embodiment of the invention. The system provides a model deployer 120 that is used convert the meta-data from the model designer 110 into one or more deployable projects each with their own set of services 130 and each generated in a form that is tailored to the server and data sources that were configured in the domain. The model deployer contains a deploy engine 1156 which is responsible for generating the deployable and executable software service(s) based on the domain model and the service model(s) selected for each deploy operation. The deploy history engine 1150 provides a record of each deployment which includes the meta data of the domain at the time of each deployment. The deployment history is utilized during the deploy process to ensure that only changed items are deployed or reconfigured and is also utilized to provide a mechanism to restore previous domain deployment configurations. The model deployer may retrieve the service model(s) that are being deployed from the model repository by utilizing the repository integration engine 1148. The repository integration engine 1148 provides an extension point for the deploy engine to integrate with version control systems to retrieve model data to be deployed. Thus, the model can be extended and/or customized by the repository integration engine 1148. The dependency engine 1152 (see 370 & See 450) is responsible for providing and maintaining a list of dependencies between various components in the domain model and service models. The dependency engine provides the capability to deploy only changed objects and their dependencies, as well as providing a visual representation of dependencies to users of the model designer 110, including the domain designer 305. The validation engine 1154 (see 380 & see 455) is responsible for validating the domain model and the service model to ensure that there are no errors or issues in the design or implementation of the model that would result in errors or issues in generated software services 130. The Deploy Naming Services 1146 are responsible for managing the names that are used for all generated deployment artifacts and ensuring that those names conform to the deployment environment where the software service(s) will be executing. This includes the names used for generated relational database tables, deployment packages, source code, etc. The deploy naming services ensure that consistent names are utilized when translating from the names used in the visual model to the names used in the deployed software service(s). The RDBMS services 1144 provide the deploy engine with information that is needed about the relational databases that will be utilized by the generated software service(s). This includes providing the appropriate database creation and modification scripts for each database type, providing the association between database column types and data object field types, etc. The deploy context services 1142 provide a common context for the deploy engine which can be accessed by each of the components of the deploy engine to share information concerning the deployment. This includes information about which project deploy is currently being deployed, which server that project is being deployed to, etc. The deploy context services 1142 are the hub for information about the deployment. The model builder plugin 1140 is an extension point in the model deployer which enables the addition of new modeling concepts and their deployment. Thus, the model can be extended and/or customized by the model builder plugin 1140. The model designer interface 355 is the extension point that allows the model designer to add new model concepts and to visually design those items within the model designer. The model builder plugin 1140 provides the complimentary extension point for the model deployer to enable the complete extension of modeling and deploying new concepts. The system includes model builders for each of the model concepts that are included in the base system. The data store builder 1136 is responsible for converting the meta data from the model that describes a data store into the artifacts which are needed to deploy and use a data store. It is responsible for managing the generation of relational database scripts when necessary as well as creating the code and deployment descriptors which are needed to persist and store data objects at service execution time. The generated software services may utilize a variety of persistence strategies to handle the physical storage of data, however each of those strategies are managed beneath the data store which acts as a platform neutral implementation of the data storage and retrieval. The data object builder 1134 is responsible for generating the code and deployment artifacts needed for each data object. This includes the low level source code for an in memory representation of the data object as well as the source code representing the persisted version of the data object and the deployment descriptors or configuration needed to register the data object with the runtime technology infrastructure. The exception builder 1132 is responsible for creating the source code and configuration information needed to implement a user defined exception which can be utilized in the executing software services. The generated exception is a concrete extension to the exception type that is defined for the hosting technology infrastructure ensuring that exceptions which are generated from within the executing software service may be escalated to the technology infrastructure for reporting and management. The logic model builder 1130 is responsible for converting the logic model into the specific implementation of the logic defined within the logic model. The logic model builder 1130 is responsible for the creation of the machine level source code and deployment and configuration information needed to implement the logic in the executing software service within the hosting technology infrastructure. The generated code includes an execution engine, variable declarations, and emitted code for each step as well as emitted code for the flow of execution as it was designed within the logic model designer. The web model builder 1138 is similar to the logic model builder and it constructs very similar code. The web model builder is also responsible for the generation of the user interface code which can be implemented as HTML as well as dynamic web content as prescribed by the hosting technology infrastructure. Resources like images and Java script, which are required for each web model are also delivered and packaged by the web model builder. Each logic step type in the system has a corresponding logic step builder which is responsible for generating the source code for a particular step type while merging the design time configuration information as it was entered within the model designer. The logic step builder interface 1128 acts as an extension point where new logic step types can be plugged in and incorporated into the model deployer. This extension point acts in unison with the step designer plugins 852. Thus, the model can be extended and/or customized by the logic step builder interface 1128. The modify data store step builder 1108 is designed to emit code for the target platform which is capable of adding or removing information from a data store which may be backed by a variety of persistence mechanisms. The generated code for the data store step merges the information regarding which data store and which variables from the logic model to include in the modification to the data store. The search data store step 1106 generates code which is capable of retrieving information from a data store using a variety of query strategies which include structured query language (SQL), XPath, as well as other translations of visually modeled criteria for limiting the set of data objects returned from the executing search data store step. The execute SQL step builder 1104 emits code which is designed to transcribe user configured SQL syntax to be executed against a particular data source and then retrieves the result of the execution and populates the data into the variables of the executing logic model as configured within the logic model utilizing the execute SQL step designer. The read file step builder 1116 generates code which can load binary information from the hosting technology infrastructures file system at a specific file location which may be variable or statically defined. The binary file content is stored in a logic model variable or field for use within the executing software service. The write file step builder 1114 emits code which can store binary data into a file on the hosting technology infrastructures file system pushing information which is available at execution time as a logic model variable. The delete file step builder 1112 generates code which is capable of removing a file from the file system. The read directory step builder 1110 emits code which can read the list of files available within a specific file system director and place the list of files in a logic model variable for use within the executing software service. The catch exception step builder 1124 emits code which is designed to detect an exception which has occurred during the execution of the logic model. The code captures the information concerning the exception and places the information in the logic model variables as configured within the catch exception step designer inside the model designer. The code is further configured to catch only those exception types that were defined to be caught within the model designer for each catch exception step. The throw exception step builder 1122 emits code which will generate an exception of the type which was configured within the throw exception step designer and will incorporate information from the executing logic model and software service as defined in the service model. The generated code utilizes the exception handling mechanisms of the hosting technology platform. The rollback transaction step builder 1120 emits code which will cause the transaction associated with the executing logic model to abandon its changes and rollback to the state that existed on the database prior to the beginning of the transaction. The commit transaction step builder 1118 emits code which is designed to commit the transaction associated with the executing logic model and ensures that each of the database modifications which were made within that transaction boundary are all implemented together and successfully. The GUI step builder 1126 is responsible for generating the user interface code that was designed with each GUI step. The GUI step code may be implemented as HTML and a combination of dynamic web content pages as prescribed by the target technology infrastructure. The GUI step builder may also create and store the resources needed by the GUI step in a file or format requisite for the target technology platform and user interface execution environment.

### Generated Services and Runtime Component

FIG. 12 sets forth details of the generated software services 130 and runtime framework 125, according to one embodiment of the invention. Each project is generated as a deployable and executable package which is completely independent of the model designer 110 and model deployer 120. The executable package contains all of the generated services 130 and runtime framework 125 for the package. The executable and deployable package can include the following components: runtime logic framework 1210 (where is responsible for the control of all application logic) and runtime web framework 1205 (which is responsible for all of the web based runtime execution).

The runtime framework 125 is the common set of executable software components that are common to all generated services 130. This runtime framework 125 is platform dependant (i.e., dependent on technology infrastructures 145) and provides a common set of interfaces to the generated code for standard execution services like transaction management, security, etc. The runtime web framework 1205 is the portion of the runtime framework 125 that is designed to drive the web layer execution of the generated services 130. The runtime logic framework 1210 is the portion of the runtime framework 125 that is designed to drive the execution of the logic of the generated services 130. Collective generated services 130 includes a series of individual generated services 1225. The generated services 1225 are the final result of the services 130 that are defined in the model designer 110 and deployed using the model deployer 120. The generated services 1225 are the user defined, dynamically generated portion of the runtime which utilize the runtime framework 1215 to execute application logic and user interfaces. The registry integration framework 1245 is responsible for providing connectivity and a standard registration interface for a wide variety of runtime registries for services 130 as well as enterprise service buses. The registry integration framework 1245 is pluggable so that new extensions may be created to integrate the generated services 1225 with one or more systems which are designed to receive information about services 130 as they become available for use. Thus, the model can be extended and/or customized by the registry integration framework 1245. The generated service initializer 1220 is generated with each generated service 1225 and it includes the information and executable(s) that are required to utilize the registry integration framework 1245 to register the service 130 with one or more systems. The information needed to connect to the registry or enterprise service bus is provided during the design of the domain within the model designer 110 and is utilized to create the generated service initializer 1220.

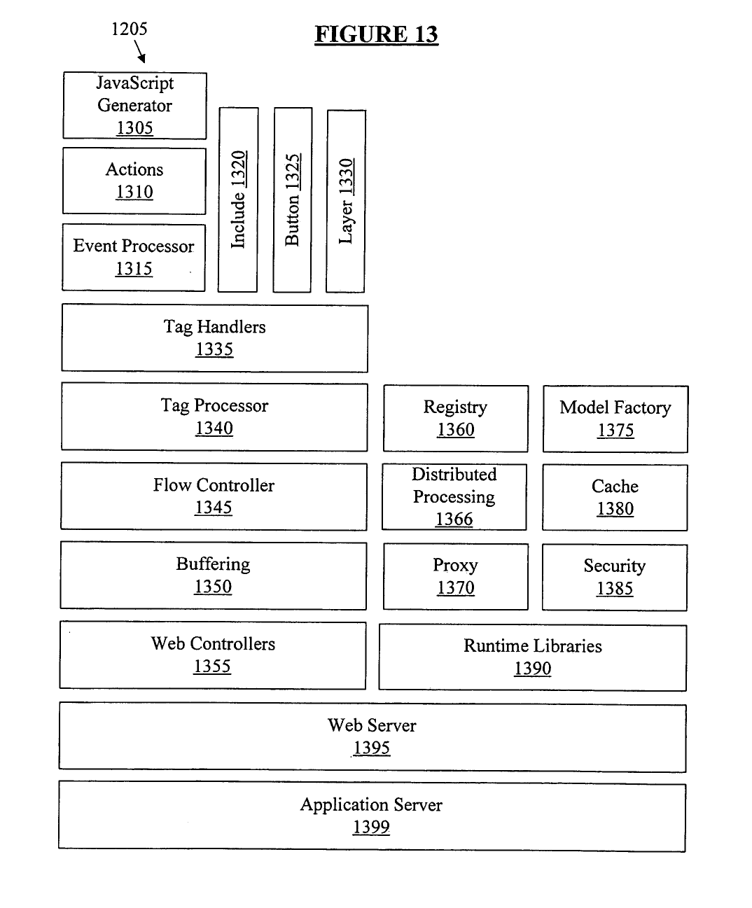

Runtime Web Framework 1205. FIG. 13 sets forth details of the runtime web framework 1205, according to one embodiment of the invention. The runtime web framework 1205 is made up of several major components which are utilized by the generated services 1225 while executing and delivering the user interface portion. FIG. 13 describes components of the runtime web framework 1205, according to one embodiment of the invention. The application server 1399 represents the execution environment of the technology infrastructure 145 where the services 130 are deployed and running. Application servers 1399 can provide low level services to running applications which range from persistence management to naming services. A web server 1395 can be responsible for the low level implementations of the web interface and execution. These services can include low level HTTP Protocol and Connection management as well as thread management and session management. Web controllers 1355 can receive requests from the executing web application running on web server 1395 as it exists within a web browser. For example, there is a web controller 1355 responsible for receiving form data from the web browser.

Buffering 1350 is responsible for managing the request and response information as it is sent and received through the web server 1395 back and forth to and from the web browser. The flow controller 1345 is responsible for dynamically determining the visual flow of execution from the end users perspective. The flow controller 1345 utilizes the meta-data captured in the model designer 110 to determine the correct flow of the user interface experience based on the actions and the events of the end user interaction. The tag processor 1340 refers to the execution engine where the dynamic web page is being processed and loaded. This may be in the form of a generated Java server page in a Java environment or an active server page in a NET based environment. The tag handler(s) 1335 are responsible for the implementation of tags which are utilized to design and implement the web interface. Each tag represents a web control or some reusable and configurable user interface concept. Each tag has a corresponding tag processor which is the runtime implementation of that tag's behavior in the generated service 1225.

The event processor 1315 is responsible for receiving web events that are generated by the end user within the web browser and responding to those web events through logic and web execution based on the design of the service 130 as it was modeled within the model designer 110. Actions 1310 represent the specific and discrete steps that can be taken when an end user on generates some type of an event through their use of the user interface. Custom actions can be defined and utilized within the model designer 110. The Java Script generator 1305 is responsible for dynamically generating the Java Script that is utilized and interpreted on the web browser to implement the web layer of the generated service 1225. Java Script is a standard scripting language that can be interpreted by most web browsers and executed within the web browsers. The include handler 1320 is the server component that knows how to process an include tag. The include tag allows a user to include one component inside of another. This allows for the modular construction of a web site. For example, a user could have a header component that contains the content that should be displayed on top of every page. The user could use an include tag to accomplish this. The include handler would insert the header component wherever the server encounters an include tag that references it. The button handler 1325 is the server component that knows how to generate the HTML required to render a button on a web page. The button handler is invoked whenever a button tag is encountered on a page as the server processes it. The layer handler 1330 is the server component that knows how to generate the HTML required to render a layer on a web page. A layer is a region that you can apply style to. For example, you could make all the text in a layer bold by applying the bold style to the layer.

The registry 1360 is a lookup service that knows where all objects are deployed. This service is used extensively in a deployed application to find resources. For example, if one web page includes another web page that is in another project, the location of that web page in the registry will be looked up. The registry 1360 can be configured to utilize information from the runtime registries that are included within the deployment domain. This allows the executing software service to incorporate and integrate at execution time with a runtime registry and/or enterprise service bus. The runtime libraries 1390 are code libraries that are used by the applications. The model factory 1375 creates instances of the models that a user has designed, after an application is deployed. Once a model has been created by the model factory, it is stored in a cache 1380 so that the same model can be used across multiple requests. Security applications 1385 have access to security services that only permit access to authorized individuals. The distributed processing services 1366 are responsible for the coordination of execution when one web model includes other web components which may be located within the same physical infrastructure or may be executing remotely. The distributed processing services 136 utilize the proxy service 1370 to allow interactive requests and responses to be distributed across various web servers by acting as a proxy for the request and then forwarding the request to the remote server. When the remote server responds, the response is received at the proxy layer and handled in the distributed processing service 1366.

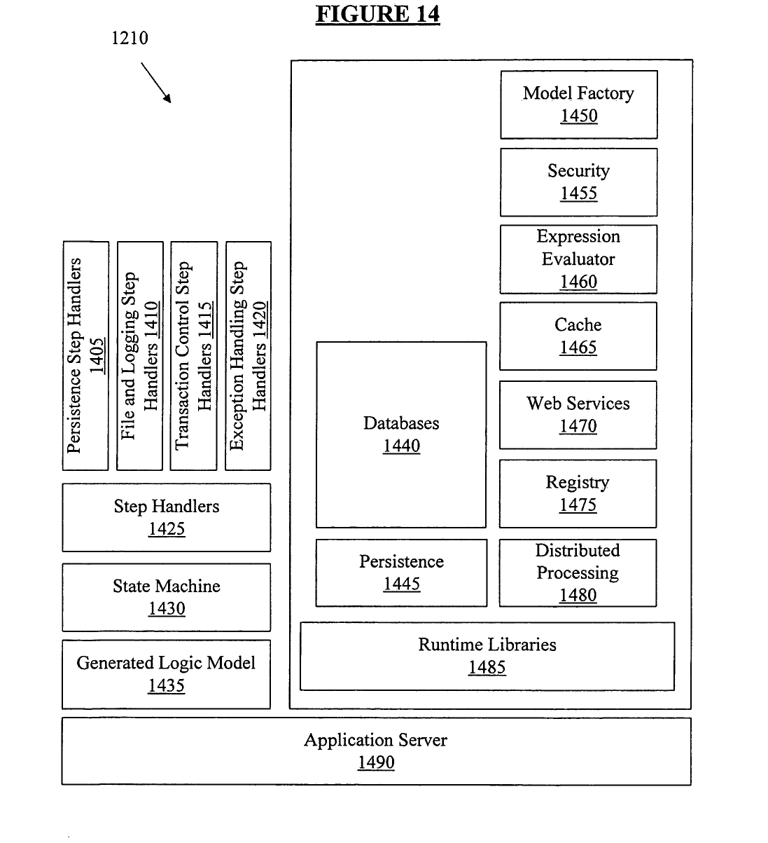

Runtime Logic Framework 1210. FIG. 14 sets forth details of the runtime logic framework 1210, according to one embodiment of the invention. The runtime logic framework 1210 is made up of several components which are utilized by the generated services 1225 to execute the logical steps that were defined within the model designer 110 and deployed from the model deployer 120. The runtime logic framework 1210 provides the execution services needed to achieve transaction management, flow control, security integration as well as other types of standard services.

An application server 1490 represents the execution environment where the services associated with runtime framework 125 are deployed and running. Application servers 1490 normally provide low level services to running applications which range from persistence management to naming services. A generated logic model 1435 is the executable form of the logic model designer 320 as it was designed within the model designer 110. The generated logic model 1435 contains the executable code required to implement each step in the model and the entry point methods needed to expose the logic model to external consumers. Each generated logic model 1435 contains a state machine 1430 which is responsible for controlling the execution flow. The state machine 1430 is a translation of the visual flow that is designed within the model designer 110 into a machine which is capable of implementing that flow including multithreading, branching, joining, conditional execution, and iteration.

Step handlers 1425 are pluggable and extendable portions responsible for the implementation of each step type. Thus, the model can be extended and/or customized by the step handlers. 1425. Each logic step type has a corresponding logic step handler 1425 which is invoked dynamically when the step is executed by the state machine 1430. Step handlers 1425 enable the design, development and deployment of complete systems and services within the visual model environment. A multitude of pre-built step types are delivered. In addition, the extension and integration of new logic step types, API invocation and web service invocation step types can be utilized.

Persistence step handlers 1405 are responsible for interacting with various types of persistence mechanisms that may be utilized within the generated services 1225. The persistence step handlers 1405 can be configured to store, search, remove and update information through the persistence layer of the application server 1490 or they may also be configured to bypass the application server 1490 and go directly to one of the relational databases that have been configured as a data source in the domain. The file and logging step handlers 1410 are responsible for general input and output routines and are also responsible for integrating with the logging mechanisms provided with the application server's 1490 execution environment. The transaction control step handlers 1415 are responsible for implementing the code needed to commit and rollback transactions and to integrate with the transaction control systems provided by the application server's 1490 runtime environment if one is provide. The exception handling step handlers 1420 provide the executable logic that is required to properly route and configure user defined and system exceptions within the executing environment.

The runtime logic framework contains a set of runtime libraries 1485 which are prepackaged libraries of software or services which are capable of being utilized within the target technology infrastructure which are normally provided by third parties to the base system and which may be classified as licensed technologies and or open source utilities which may be necessary for the operation of the generated software services. These libraries may include database drivers and general utilities and minimize the amount of generated code required for each software service. The runtime libraries may also include software definitions which were configured by the service designer as being required by their service model during execution. The persistence layer 1445 provides the super classes and implementations of the lower level integration with the persistence infrastructure of the target technology infrastructure. These persistence classes include code responsible for storing and retrieving data as well a pluggable architecture for interacting with various database types. The persistence layer provides utility methods for executing query language commands to each database type as well as formatting and other database specific utilities. The persistence layer 1445 interacts directly with one or more physical relational databases 1440. The distributed processing services 1480 are responsible for the coordination of execution when one software service invokes another software service which may be located within the same physical infrastructure or may be executing remotely.

The distributed processing services provide a mechanism to look up services which have been deployed and are available and further coordinates their invocation and the results of the invocation. The registry layer 1475 provides a set of classes which can interact with a runtime registry which provides the location of software services. The software services may be configured to interact with one or more runtime registries and can be configured to both publish their own service information and to retrieve other services information from these registries through the registry integration layer. The model can be extended and/or customized by the registry layer 1475. The web services layer 1470 provides the infrastructure needed to handle inbound web service requests and route them to the appropriate software service. The cache 1465 provides object caching to the executing software services and is responsible for synchronizing data objects which are held in memory as variables in logic models. The cache provides performance enhancements as well as data synchronization services. The expression evaluator 1460 layer is responsible for converting expressions like variable assignments and logical comparisons of data during service execution. The security layer 1455 is responsible for interacting with the security systems of the technology infrastructure where the software services are executing to provide information and authentication to the executing logic model. This includes the set of roles that a logged in user may be in or whether the logic model is being executed by an authenticated or unauthenticated user. The model factory 1450 is responsible for creating and managing instances of the logic models that are utilized within a generated software service. The model factory ensures that each instance of a logic model that is executed has been properly configured and created prior to being used.

### Methodology

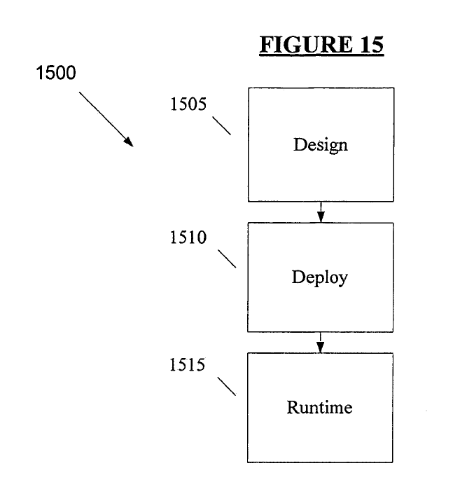

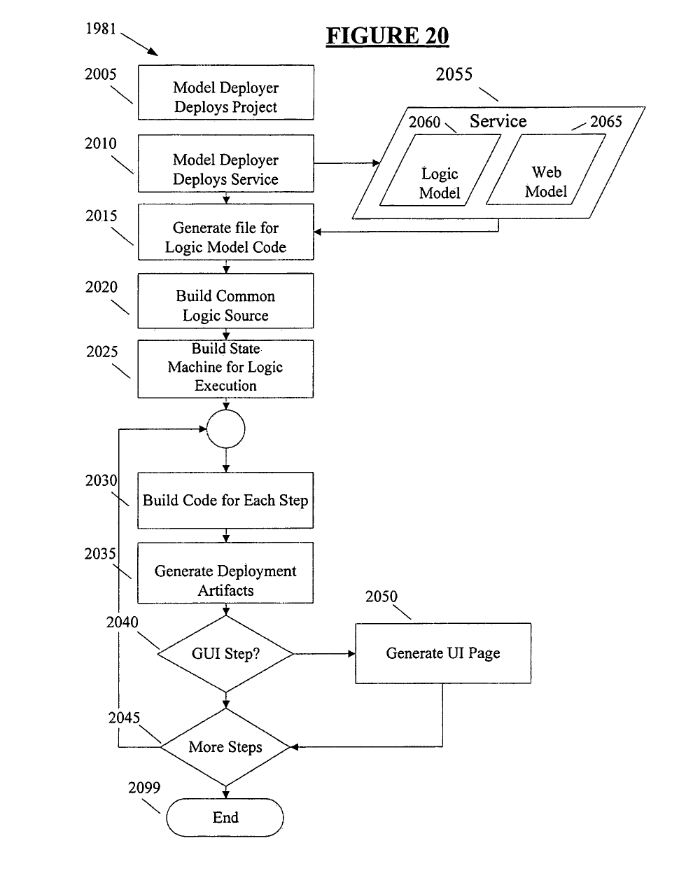

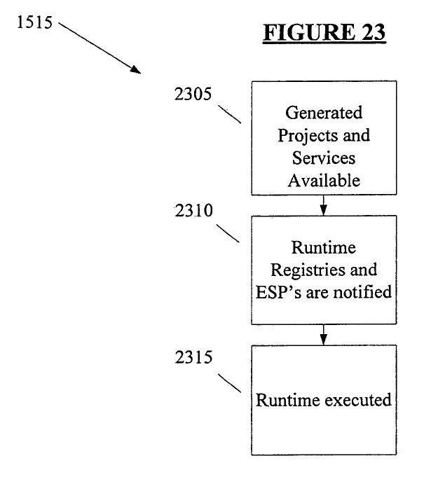

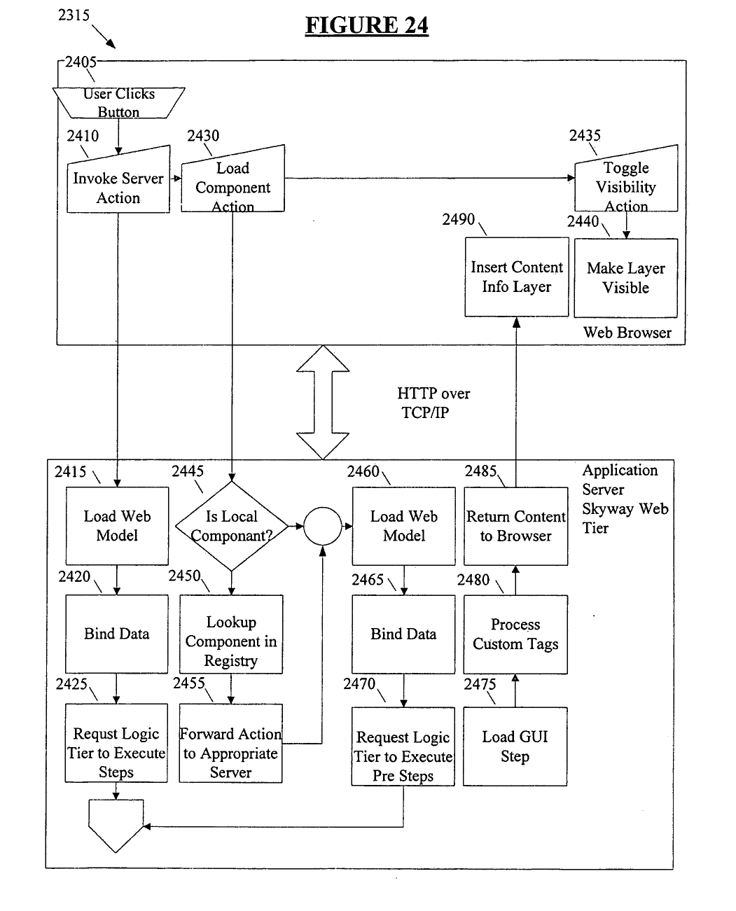

FIG. 15 illustrates a method of creating, deploying, and utilizing a service, according to one embodiment of the invention. In 1505, the service is designed in a visual modeling environment such that low level machine centric and/or platform dependent programming language is not used. The service is capable of being implemented across an enterprise. In 1510, the service is deployed in a plurality of technology infrastructures within the enterprise by tailoring the service for each technology infrastructure. More details regarding 1510 are described below with reference to FIG. 18. In 1515, the service is executed at each technology infrastructure in a manner that interacts with enterprise software or other technology infrastructures. More details regarding 1515 are described below with reference to FIG. 23.

### Designing the Service

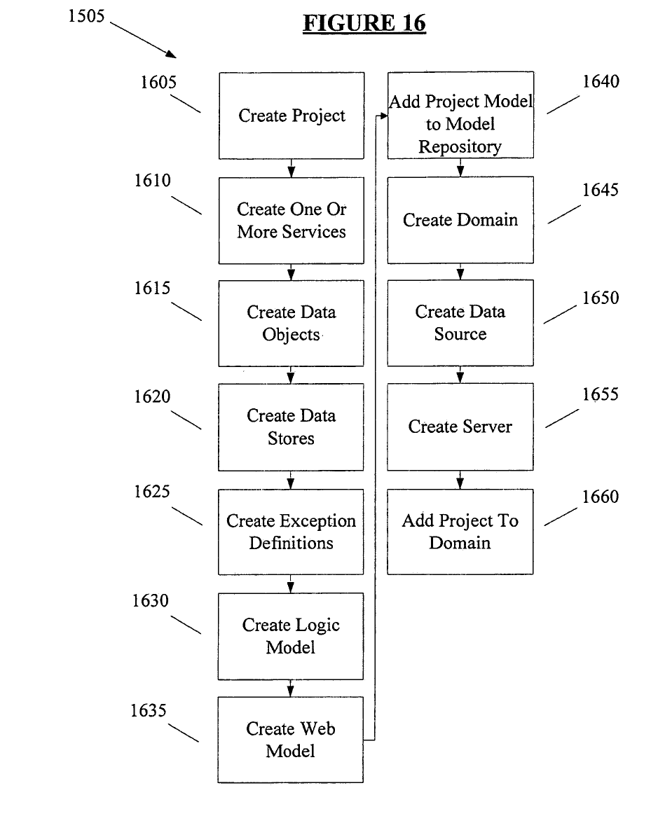

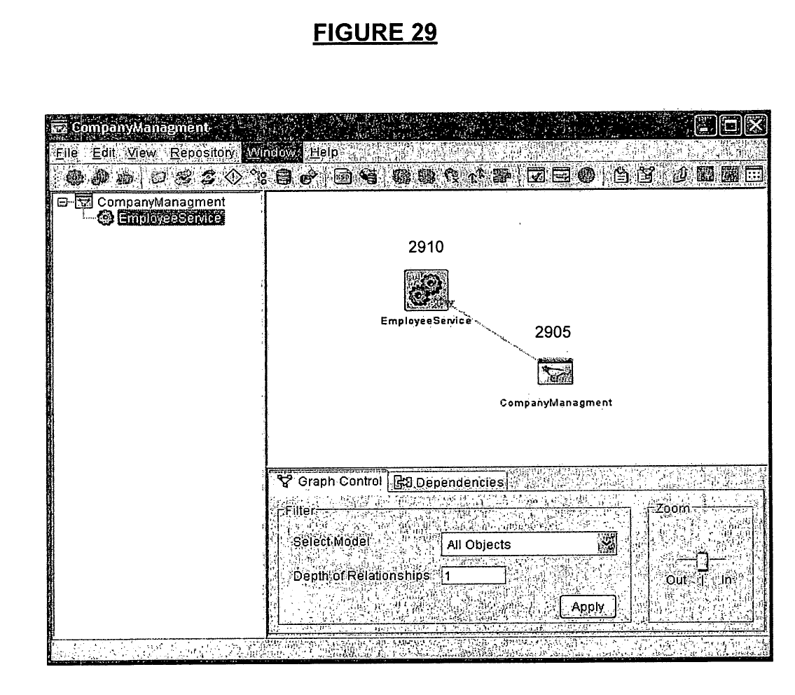

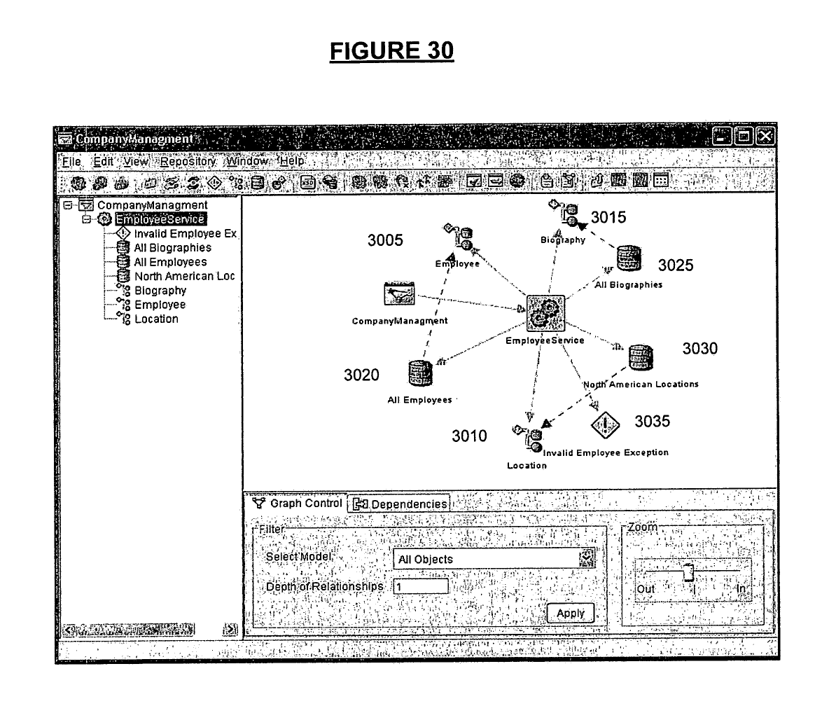

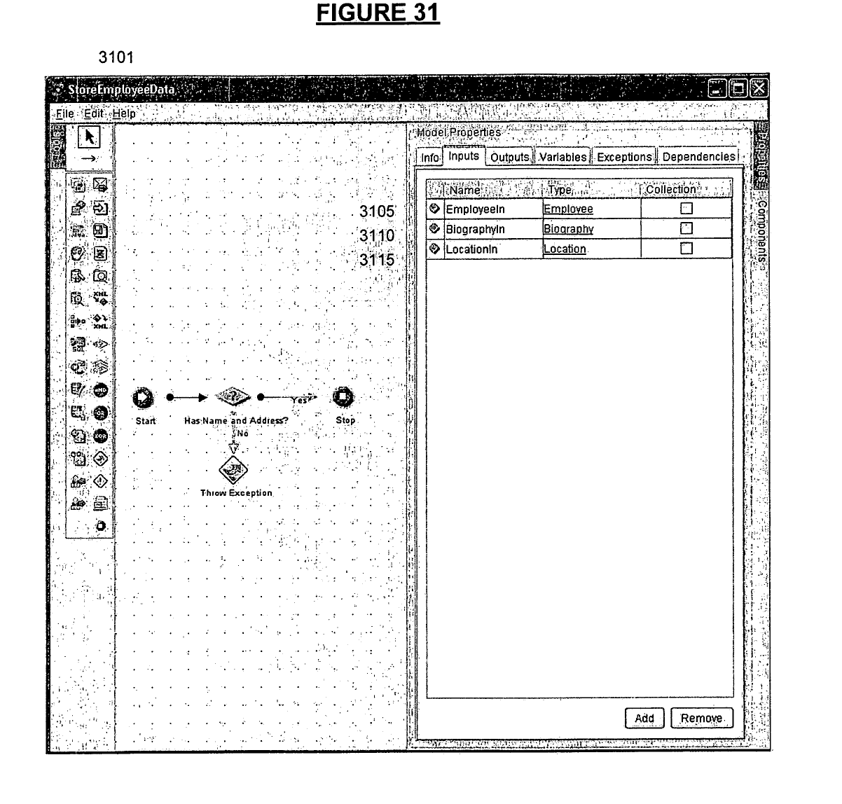

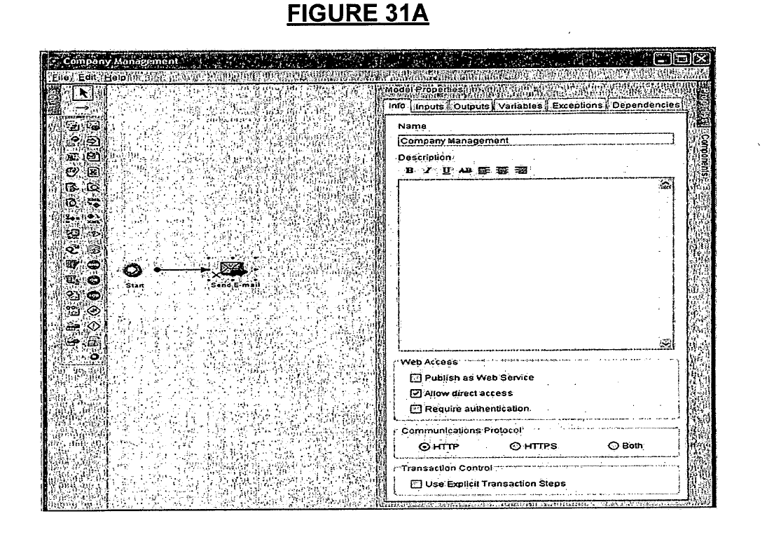

FIG. 16 illustrates details of designing the service 1505, according to one embodiment of the invention. In 1605, a user interface is provided to create a project which is a top level of organization and deployment within the enterprise. The project has a name and a collection of services 130 which are the executable endpoints defined within the project. FIG. 29 illustrates a Company Management project 2905.

In 1610, once the project has been created, services within the project which contain the implementation details can be created (e.g., by a service designer). FIG. 29 illustrates an Employee Service 2910 within a Company Management project 2905. Implementation details can include data objects, data stores, exception definitions, logic models, and web models. The creation of each of these implementation details is described below. Each service 130 represents a collection of these items that are grouped together logically and that can be accessed when the model deployer 120 deploys the project and its services 130.

In 1615, data objects are created. Data Objects are definitions of complex types in modeling language and are analogous to complex types in XML, or structures in many programming languages. Data objects can be created in the system through the system interface by defining each field and relationship, or by discovering the data object definitions from other sources. These sources may include relational database schema, XML schema, programming object models, etc. Data objects define the nouns of the system, such as employee and company, and are meant to allow service modelers to define their data model using terms that are meaningful to the enterprise or services that they are designing. FIG. 30 illustrates data objects Employees 3005, Location 3010, and Biography 3015. Each data object can also contain fields with names and types.

In 1620, data stores are created. Data stores are databases or logical storage areas for data objects. Data Stores represent and extrapolation of the persistence engine that is utilized in the running Service to persist data. FIG. 30 illustrates data stores All Employees 3020, All Biographies 3025, and North American Locations 3030. Once a Data Store has been created in the Model Designer, it can be used within a logic model through various logic steps to add, update, search and remove data from the database.

In 1625, exception(s) are created. An exception is a user definition that may be utilized within logic models and web models to design systems to detect and respond to error conditions or exception states in a way that is dynamic and configurable within the logic models and web models. FIG. 30 illustrates an Invalid Employee Exception 3035. After creating a user defined exception, a service designer can then implement logic to create and detect instances of that exception type.

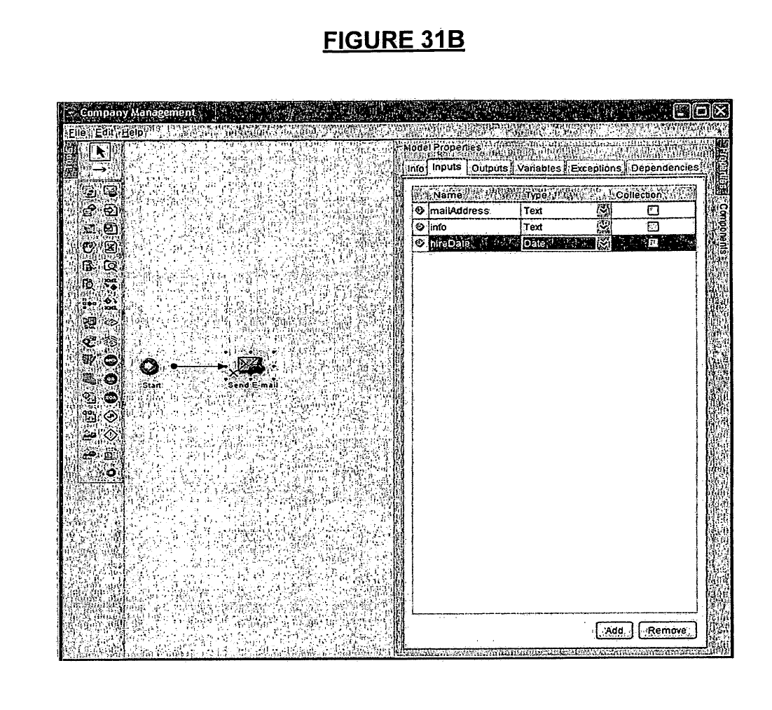

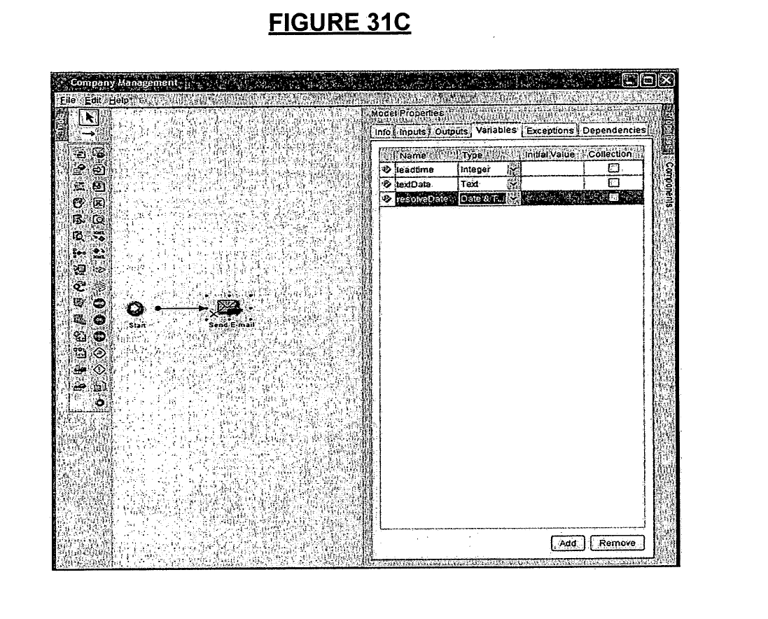

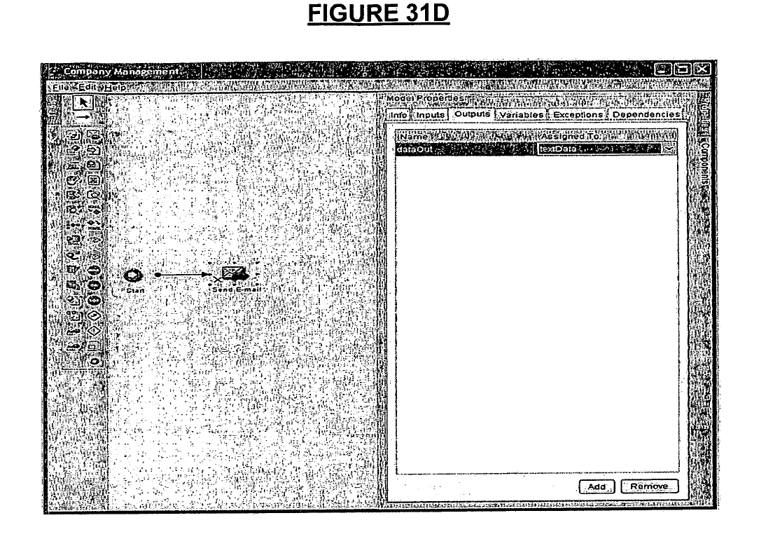

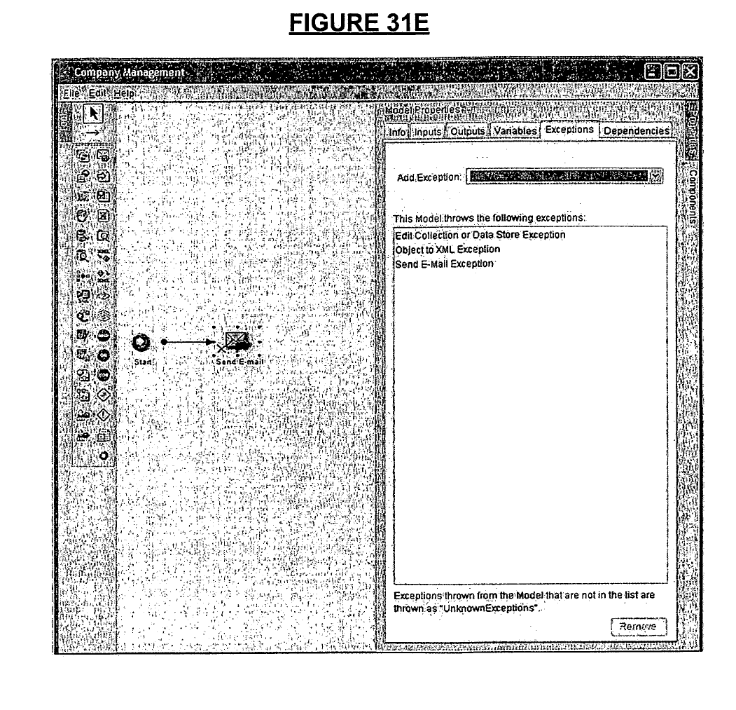

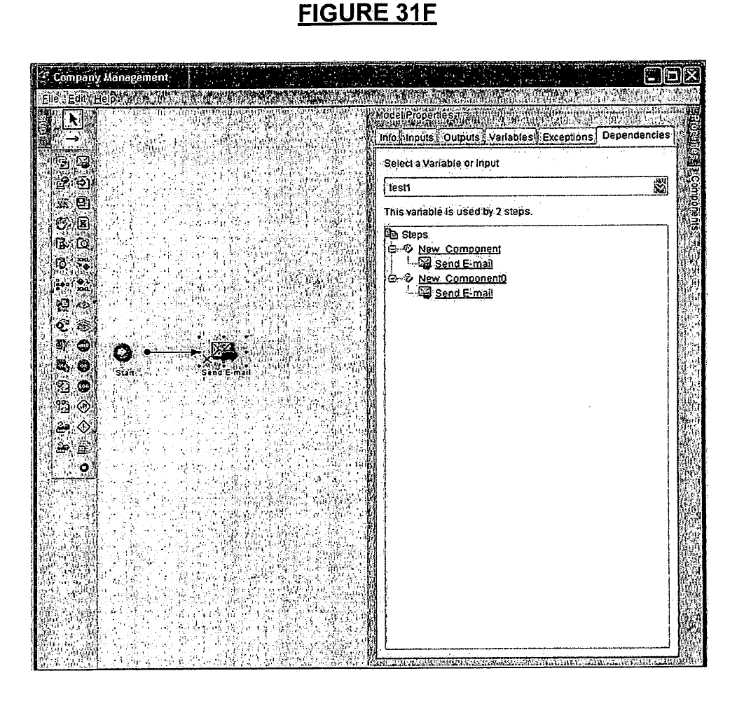

In 1630, a logic model is created. The logic model is the visual representation of an operation of a service 130. Logic models can represent specific implementation details for the logic of the service 130 being designed. Logic models can define inputs, outputs, variables, exceptions, and dependencies (i.e., one or more logic components which represent the logical steps of execution). Thus, for example, FIG. 31 illustrates a logic model named Store Employee Data 3101, which is defined to take three inputs: Employee In 3105, Biography In 3110, and Location In 3115. FIG. 31 also has tabs for info, inputs, outputs, variable, exceptions, and dependencies. FIG. 31A is a screen shot illustrating the info panel. The info panel in the logic model designer contains general configuration controls to allow modelers to give each logic model a name and description and to specify common attributes, such as whether or not to expose the logic model as a web service. FIG. 31B is a screen shot illustrating the inputs tab, which is where inputs to the logic model can be defined. Inputs are variables in the logic model which can be defined and set outside of the logic model and then passed into the logic model when it is executed. FIG. 31C is a screen shot illustrating the variables tab. Variables are named holders of information or values which are utilized by an executing logic model. These values can be utilized in any of the logic model steps. FIG. 3D is a screen shot illustrating the outputs tab. Outputs are the values that will be returned to the caller of the executing logic model. Outputs normally represent the outcome or result of some type of logical operations or processing. FIG. 31E is a screen shot illustrating the exceptions tab. The exceptions tab allows users to configure the set of exceptions that each logic model could potentially throw as a result of its processing. FIG. 31F is a screen shot illustrating the dependencies tab. The dependencies tab shows which logic steps and logic components are using which variables. This simplifies the process of determining the set of steps that may need to change when a variable is modified or deleted or when the logical flow needs to be changed. Once a logic model has been defined, the service 130 can expose the logic model as an operation which can be executed discretely within the generated service 130. Thus, for example, FIG. 32 illustrates a logic component named Check Employee 3205, which is designed to validate the data passed in the input called Employee In 3105 and to throw a new Invalid Employee Exception 3210 if the data is not valid. This demonstrates the use of user defined exceptions within the logic model. Once a logic model has been defined, a logic component can be created with steps that are designed to persist the data (i.e., save the data in the system) passed into the logic model after validating the data to ensure it is correct. Thus, for example, in FIG. 33, if there is not an exception in 3305, the employee data is persisted 3310, and the transaction is committed in 3315. If the employee data is invalid or if there are any exceptions, the transaction is rolled back in 3320 and the exception is logged in 3325.

The invocation of the logic model can be either internal to the system through logic model to logic model invocations or web model to logic model invocations. The invocation can also be external through web service operation interfaces and endpoints that can be automatically generated by the model deployer 120.

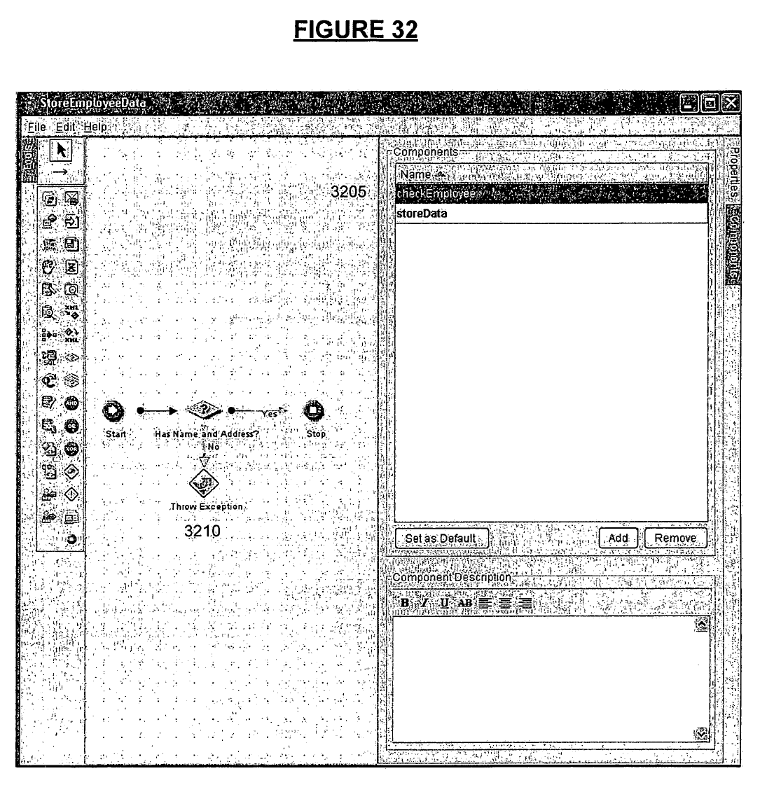

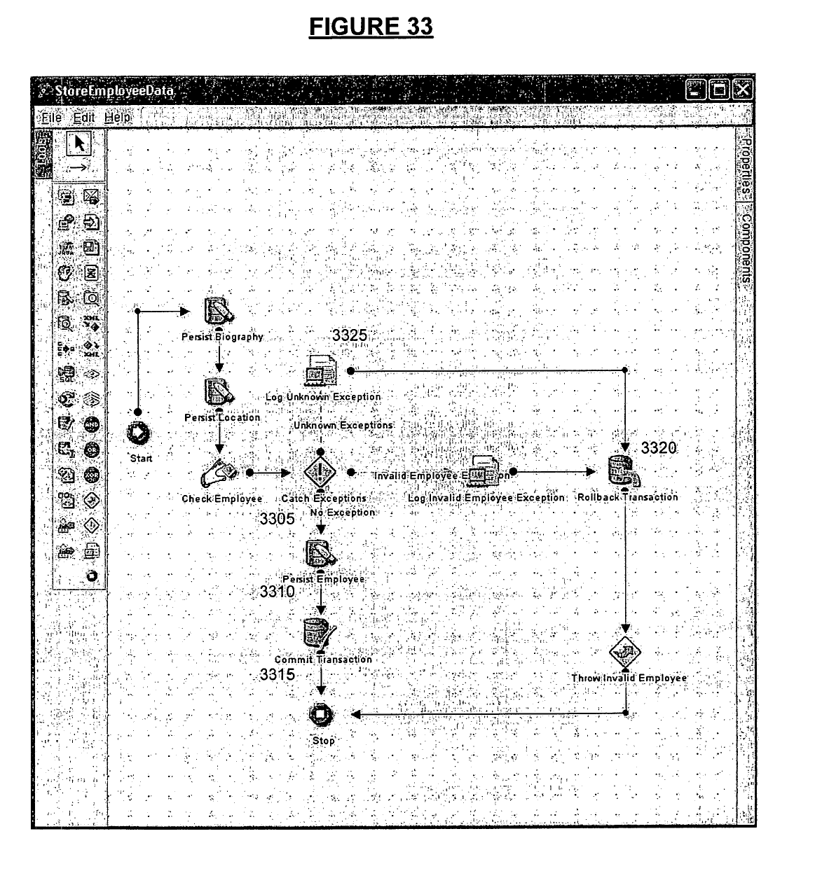

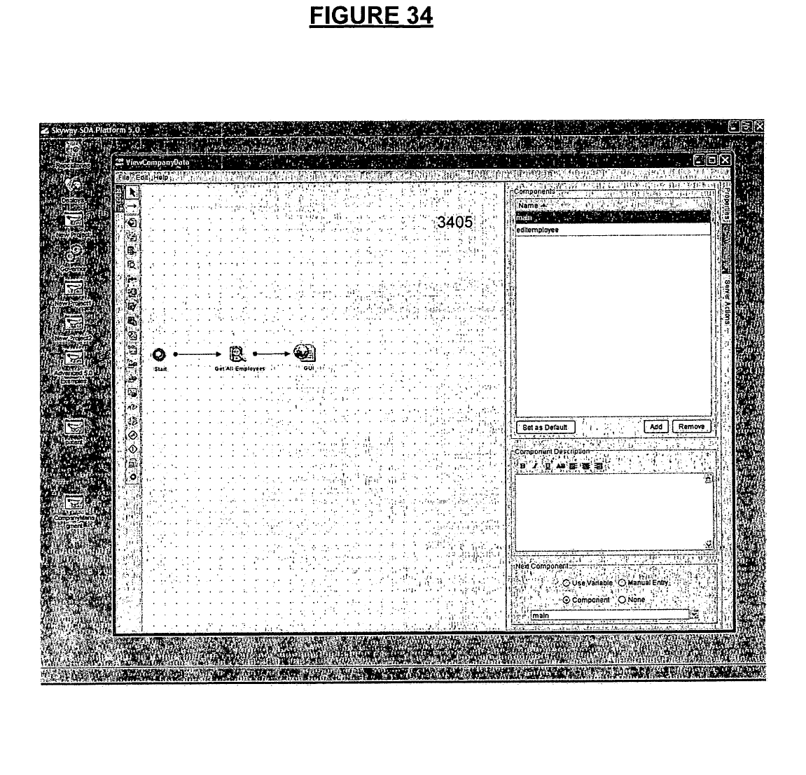

In 1635, a web model is created. The web model contains the details of the user interface design as well as the design of the logic that is performed when various user interface elements are utilized or rendered. A web model is very similar to a logic model. However, it is specifically tailored to represent the meta-data needed to automatically generate the web user interface portion of the service. FIG. 34 illustrates a web mode for the Employee Service. A default component Main 3405 is created to display all employees in the enterprise. The Main component 3405 contains a collection searcher step that loads all of the employee records from the database and puts them in a web model variable called All Employees. In addition, as illustrated in the example of FIG. 35, the user is allowed to open a user interface (UI) editor 3505 to build a web page that displays the employees in the All Employees web model variable 3510.

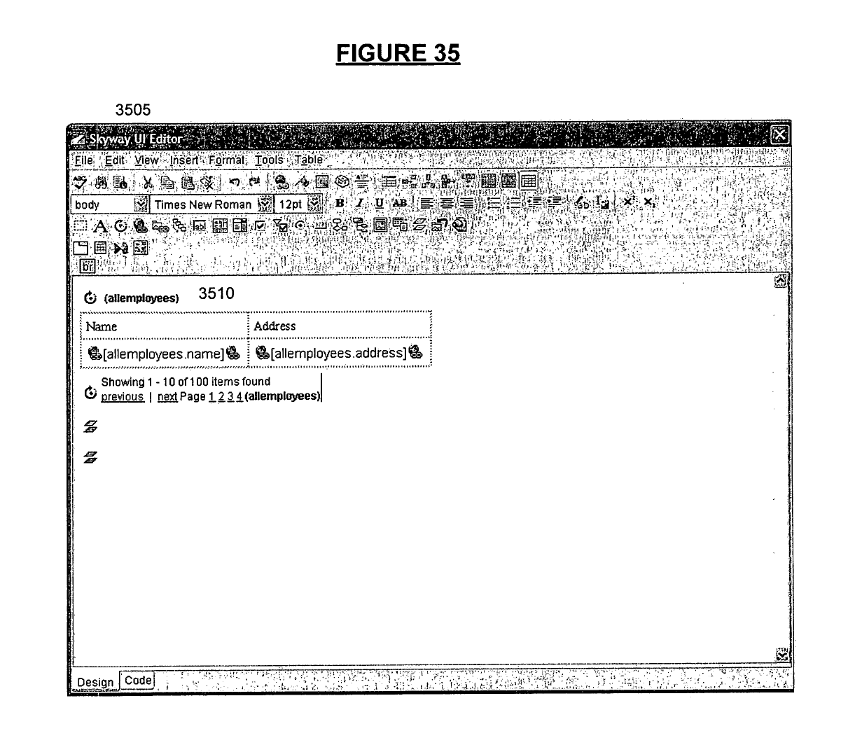

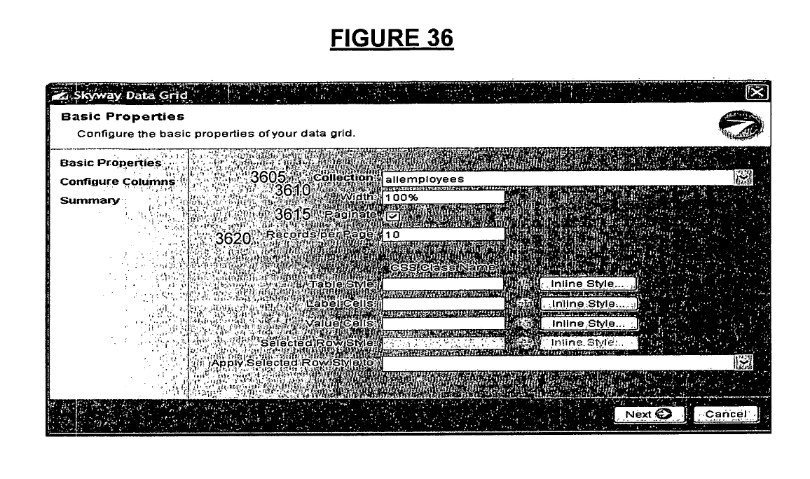

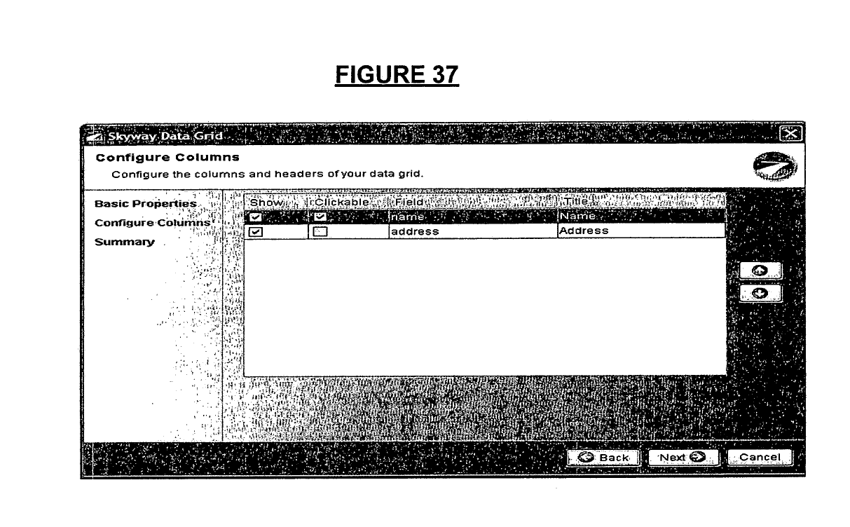

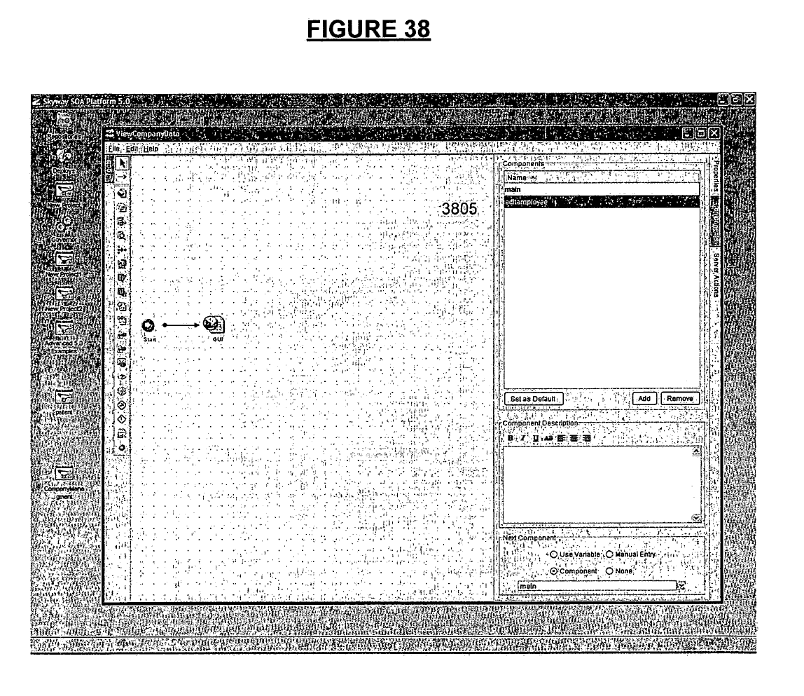

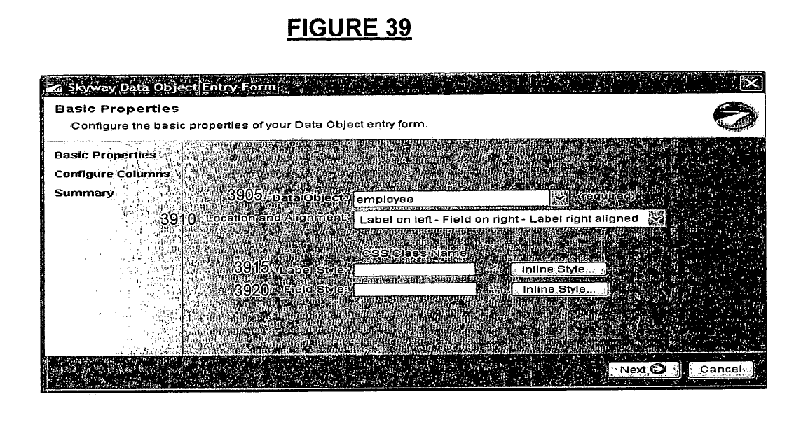

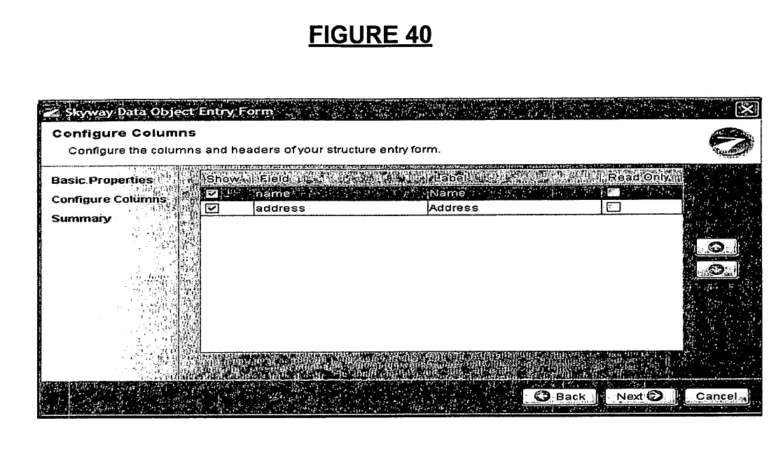

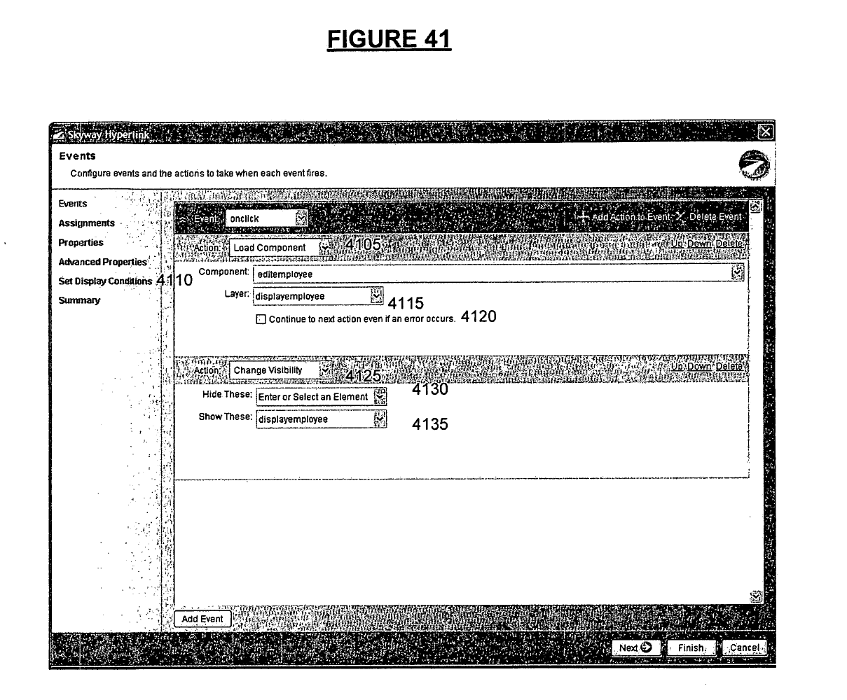

Additional functionality is available. For example, as illustrated in FIG. 36, the user can use a data grid wizard (i.e., web control template) to build a section of the web page that displays all of the employee records in the All Employees web model variable. The user can choose the collection All Employees 3605 from a drop down list, indicate the width 3620, check the paginate box 3610, and indicate 10 records per page 3615, causing ten employee records at a time to be displayed. In FIG. 37, the user can select which employee fields to display on the web page. In FIG. 38, the user can create another component called Edit Employee 3805, which contains a form that allows users to edit information about an employee. FIG. 39 illustrates an edit employee form. The user chooses to edit the data object Employee 3905. The user can choose the location and alignment 3910 of the data, the label style 3915, and the field style 3920. In FIG. 40, the user can select the fields to show in the employee form. FIG. 41 allows the user to name a hyperlink that can be clicked to edit the employee record. The user chooses the event to be On Click 4140. The action is chosen to be Load Component 4105. The component is Edit Employee 4110. The Layer is Display Employee 4115. The user can indicate in checkbox 4120 that the service 130 should continue to the next action even if an error occurs. Another action is chosen to be Change Visibility 4125. The user can designate that for this action, certain elements should be hidden 4130, and certain elements should be displayed 4135.

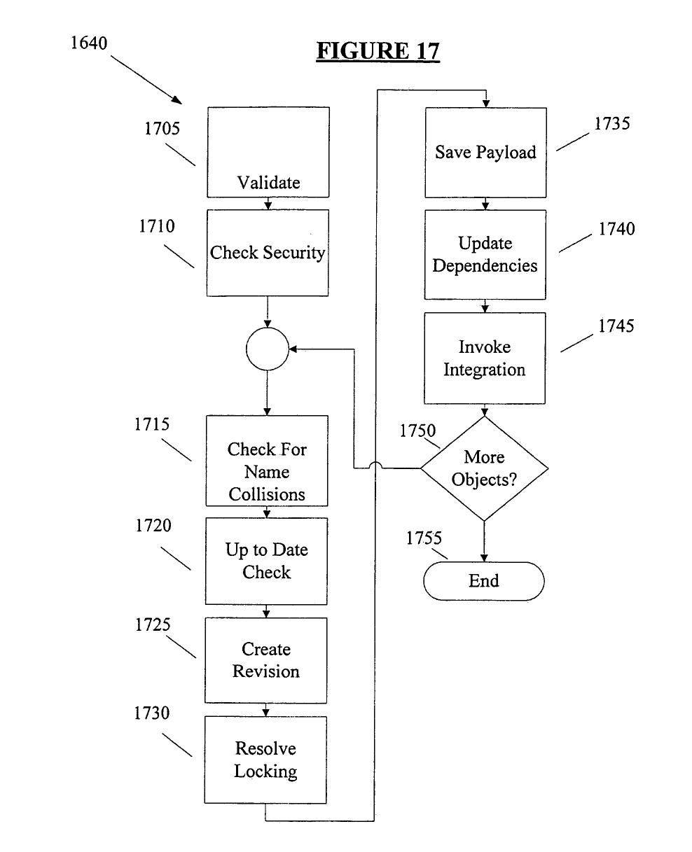

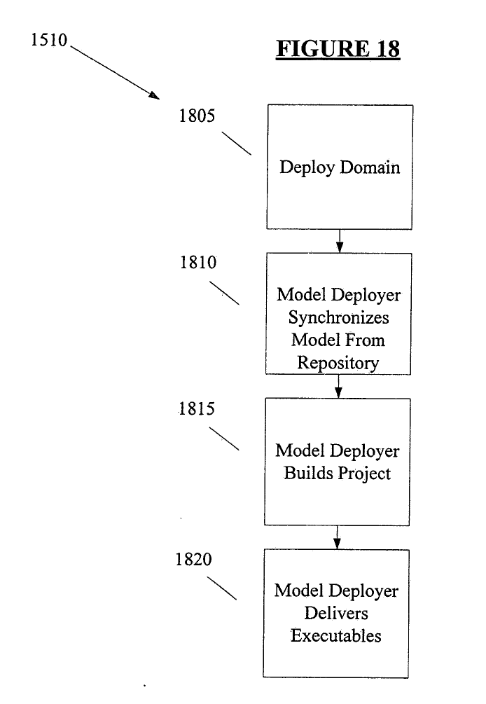

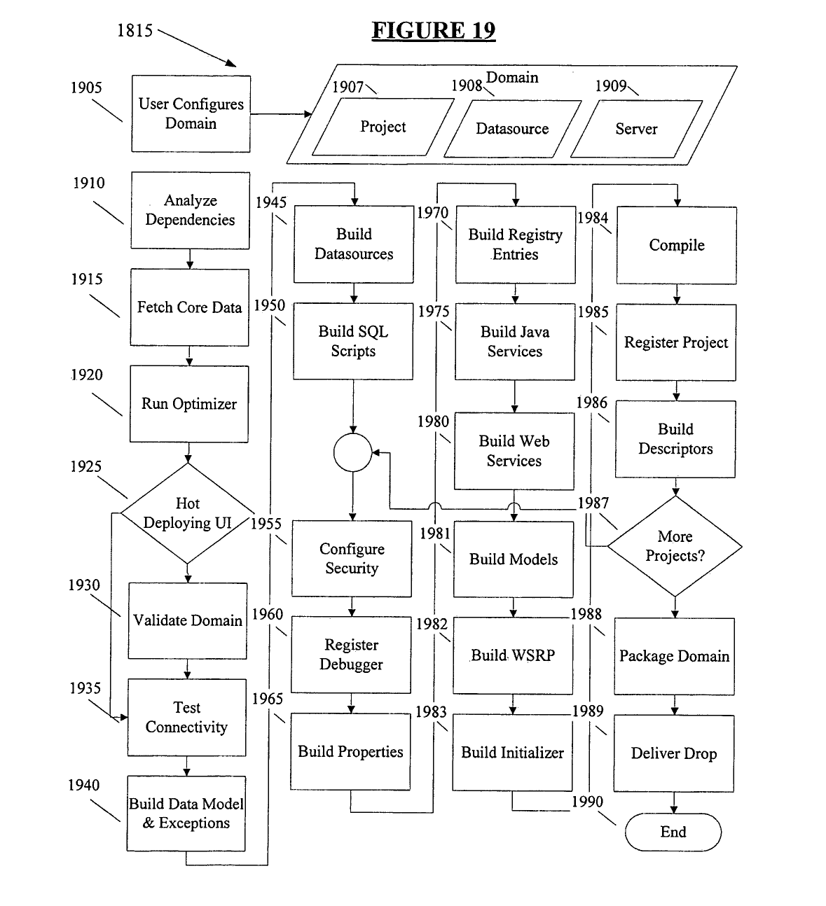

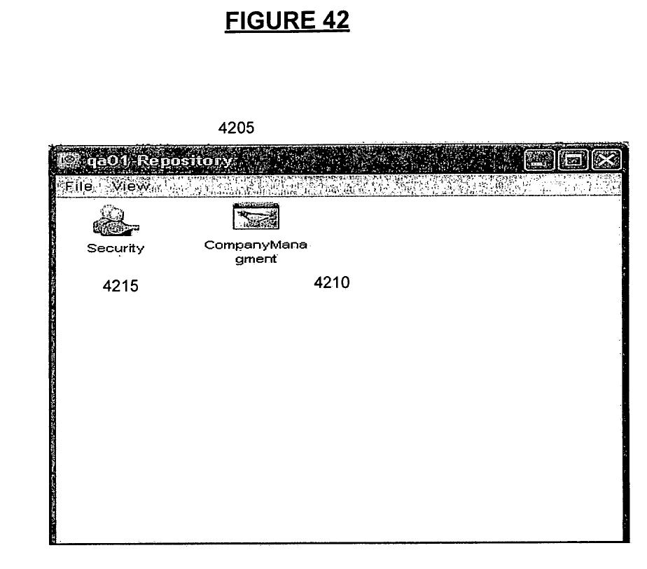

In 1640, the project model, which includes the logic and web model, is added and synchronized to the model repository 115. The model repository offers standard version management and version control facilities for the project models produced with model designer 110. The model repository 115 also provides a location where the model deployer 120 can retrieve project model information for use during the deploy phase. FIG. 42 illustrates Repository 4205, and the project model Company Management 4210. A security feature 4115 can be utilized. More details concerning this action are described below with regard to FIG. 17.

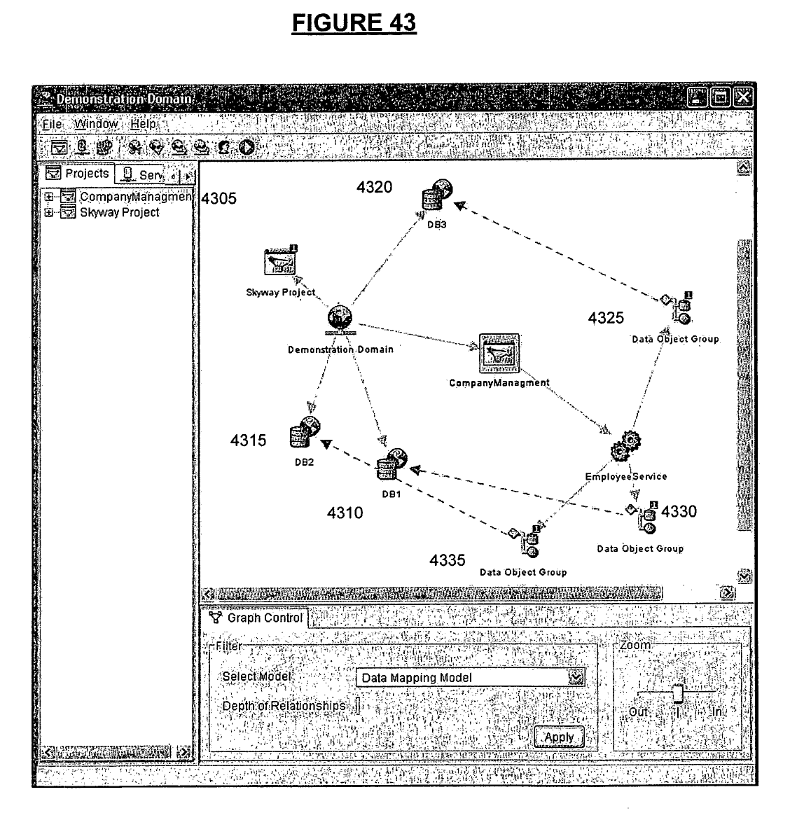

In 1645, a domain is created. Users can create and manage domains, which represent the physical system resources that will be utilized to execute the executable project package 101. For example, an enterprise may have one domain called Quality Assurance where they use the Model Deployer 120 to deploy a certain version of a project model that represents new development that must be tested. They may also define a domain called Production where the previously tested version of a project model is deployed for use by the end user community. The domain can contain one or more packages 101, data sources and project models. Thus, for example, FIG. 43 illustrates a domain to deploy the Company Management project model 4305. Within this domain, there are three data sources 4310, 4315, and 4320 each bound to one of the data objects 4325, 4330, or 4335, and each representing an XA compatible database system. An XA compatible database system is one which can support transactions which span multiple physical and logical databases allowing all of the systems to either commit or rollback their changes in unison, ensuring that changes are either made successfully to all databases or to none of the databases. This capability for the management of transactions is described as being ACID in that the following characteristics of the transaction are maintained: atomicity, consistency, isolation, and durability.

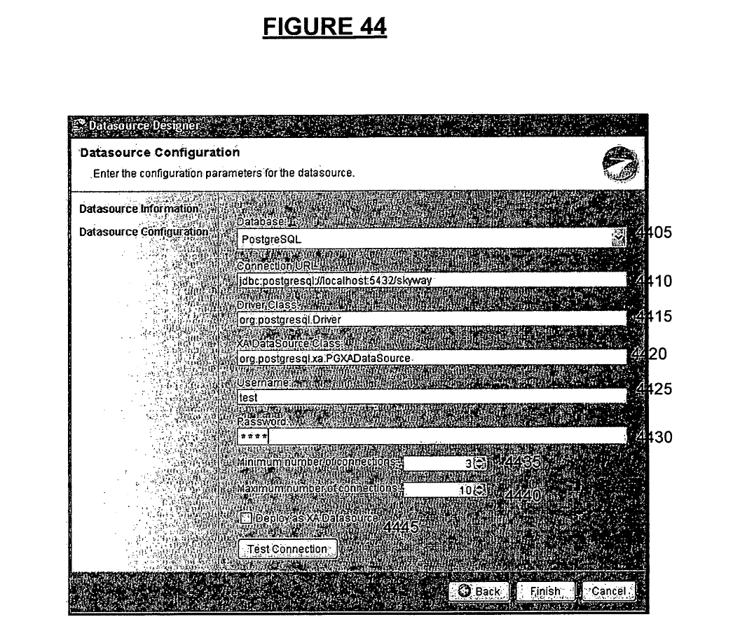

In 1650, a data source is created. A data source is a specific instance (e.g., copy) of a database that can be used by the package 101 that is generated by the model deployer 120. Each domain may have many data sources and each project model may also have many data sources. Some project models may utilize no data source because their packages 101 do not persist any data. FIG. 44 is an example of creating a data source. The following fields are included: database name 4405, URL connection 4410, driver class, 4415, XA data source class 4420, user name 4425, and password 4430, maximum number of connections 4435, maximum number of connections 4440, and whether or not to deploy as a XA data source 4445.

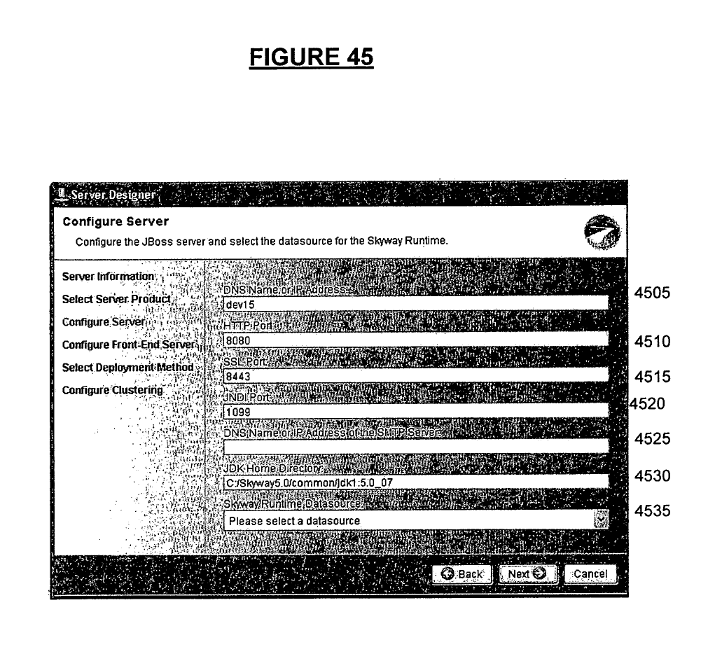

In 1655, a server is created. With the domain, the service designer 110 can create one or more servers (e.g., application servers) representing the physical machine location and resources that would house the generated project model and its services 130 in the technology infrastructure 145. FIG. 45 illustrates an example of creating a server. The following fields are included: DNS name or IP address 4505, which represents the network location that the machine can be reached at through TCP/IP; HTTP port 4510, which specifies which port the HTTP service is available on. This is the port that the web server will respond to HTTP Requests on; SSL port 4515, which is the secure socket layer port which the web server will respond to secure web communications on; JNDI port 4520, which represents the port the Java naming and director service may listen on; DNS name or IP address of SMTP server 4525, which represents the address of the email server; JDK home directory 4530, which represents the location of the Java development kit which may be utilized as part of the deployment when deploying to a Java enabled technology infrastructure; runtime data source 4535, which represents the data source which will be used to store execution data that is needed by the executing software service, but that is not user defined. This includes information about the current state of execution and shared variable state.

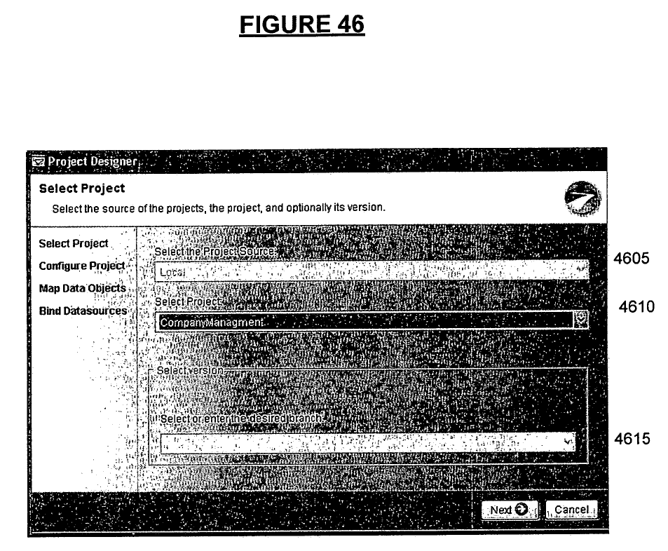

In 1660, the project model is added to the domain. Once the Domain has been configured, the service designer 110 can add one or more project model to the domain so that they can be validated and deployed by the model deployer 120. The project models are added by finding them within the model repository 115, and selecting the branch or label that should be deployed. This helps ensure that model deployments are from specific versions of project models. FIG. 46 is an example of adding the project models to a domain. The project source 4605 can be selected. The project 4610, and the version 4615, can also be selected.

Adding Project Model to Model Repository 1640. FIG. 17 illustrates details of adding the project model to the model repository 1640, according to one embodiment of the invention. In 1705, validation of the project model is completed. In 1710, the security of the project model is checked. In 1715, the project model is checked for name collisions. In 1720, the project model is checked to validate that the version being committed is the most recent version, and not a historical version that has already been overwritten. In 1725, a revision level designation is created. In 1730, locking is resolved by relinquishing any locks on the model that is being committed In 1735 the payload is saved. The payload is the model which is being versioned and committed. In 1740, the dependencies between the item being committed and other items in the repository are resolved and stored with the dependency engine. In 1745, an extension point is invoked which allows custom repository handlers to be written and invoked when ever an item is persisted and committed in the repository. This allows other systems to manage and monitor the contents of the repository enabling a wide set of integration options. In 1750, it is determined if there are more objects in the project model. If yes, the process returns to 1715 and repeats. If not, the process ends in 1755.

### Deploying the Service

FIG. 18 illustrates details of deploying the service 1510, according to one embodiment of the invention. In 1805, the domain is deployed. In 1810, the model deployer 120 synchronizes the project model from the model repository 115. In 1815, the model deployer 1820 builds the project 125. In 1820, the model deployer 120 delivers the services 130 and the framework 125 of the executable project package 101 to the technology infrastructures 145 so the services can be executed.

Building the Project Mode 1815. FIG. 19 illustrates details of the model deployer building the project model 1815, according to one embodiment of the invention. In 1905, the user configures the domain by creating one or more data sources and configuring one or more servers. At least one project is also added to the domain. The project is configured to utilize the data source(s) and is targeted to one of the configured servers. These steps represent the linkage of the service Model to the domain Model. In 1910, the dependencies are analyzed by having the model deployer 120 request dependency data to make sure the domain contains all projects that are dependent on one another. A domain cannot be deployed if there is an unresolved dependency. In 1915, the service models are retrieved from the model repository 120. Model projects inside a domain can be stored in separate repositories. All of the service models in the domain's projects are retrieved. This includes data objects, data stores, Java services, web services, web models and logic models. In 1920, the run optimizer analyzes the domain and determines what has changed since the last successful deployment of the domain. In 1925, it is determined whether or not the deployer can simply update the User Interface files or whether the Logic has changed which will require code generation. In 1930, the domain data and objects associated with each project model are validated by the model deployer 120 by inspecting every aspect of the service model and the domain model and verifying that all required configuration data has been provided and that all dependencies have been resolved. The dependency engine is utilized to make sure that all dependent services are included in the same deployment domain, and if there are any missing dependencies, they will be described in a deployment message. The dependency engine inspects the attributes of the model to derive the linkages between various service model constructs. For example, if a logic model defines a variable called current Company and sets the type of the variable to be the data object company, there will now be a dependency between the logic model and the data object. If the logic model is deployed in a domain where the company data object is not configured to be deployed, it will result in a deployment exception. In 1935, the model deployer 120 tests connections to each data source and server referenced in the domain. In 1940, the model deployer 120 builds the project model and exceptions by generating the code for all data objects in the domain and any user defined exceptions. In 1945, the model deployer 120 builds the data source definition and configuration scripts for any data source that is configured within the domain. In 1950, the model deployer 120 builds the SQL scripts to create the database tables backing any of the persisted data objects in the domain. In 1955, the model deployer 120 builds any configuration files or scripts needed to configure the security services of the targeted technology infrastructures 145 as well as any security configuration information that is needed by the deployed services 130 for dynamic runtime security integration. In 1960, the model deployer 120 registers a domain service that provides debugging services for the domain. In 1965, the model deployer builds any configuration files or property files that are needed to dynamically configure the generated services 130 when they are deployed. These property files contain information about the deploy environment and the nature of the technology infrastructure that will host the generated software service. In 1970, the model deployer 120 builds XML files containing all of the information needed by each project to find and communicate with other projects in the domain. Each project deployment will contain an XML file with its location specific information in it. When the project is activated (e.g. deployed), it sends this information to the domain registry. Once the registry has the information for a project, other projects in the domain can ask the registry for the location of other projects in the domain. In 1975, the model deployer 120 saves all of the JAR files backing any Java Services in a project. These JAR files will be packaged in the EAR file created for the project. In 1980, web services are transformed into Java services when they are discovered.

In 1981, the model deployer 120 generates the source code for all of the web models and logic models in the domain. For each logic model, a logic code file is created that incorporates the meta-data that was captured by the model designer 120 regarding the flow of execution and definition of the logic model. For each web model, a logic code file is created that incorporates the data that was captured by the model designer 120 regarding the flow of execution as well as the logical steps to be executed based on the end users interaction with the generated web interfaces. Each component within the web model is generated as a dynamic web page that is targeted for the supporting software platform where the service 130 will run. The dynamic web page contains the implementation of the User Interface that was designed with each Component.

Building of Models 1981. FIG. 20 illustrates details of the building of the models, set forth in 1981 of FIG. 19, according to one embodiment of the invention. In 2005, the model deployer 120 deploys the project model. This step creates the working space for generating and deploying the project's services and establishes a deploy context which is used by the deploy engine to coordinate the deployment activities. In 2010, the model deployer 120 deploys the service(s) 130. Since each project may have one or more services, this step repeats until each service has been generated. The model deployer uses the meta-data from the service to create the code that is used to invoke the service and expose the service as a web service if so configured in the model designer. In 2015, the file for the logic model is generated. Each service may contain many logic models and many web models and so this step repeats for each model in the service. The file that is generated is the source code file where the logic components and logic steps will be translated into methods and code within this file. In 2020, common logic is built which represents the generated source code which is independent of any logic step. This includes the general execution methods and initialization methods. In 2025, the state machine for logic execution is built, which is the code that controls the flow of execution for the logic model. The state machine is a low level machine language interpretation of the visual execution flow as it was designed within the logic model designer. The state machine implements code that moves the execution state from one method to another until the execution is complete. In 2030, the model deployer utilizes a template based mechanism to build the code for each step. The data that was captured within the model designer 110 is merged with the code template that is required for the target technology infrastructures 145 by the logic step builder. In one embodiment, the logic step builder can be configured to build code for any step type as well as custom step types defined outside of the enterprise. For the transaction step, the model deployer 120 utilizes the logic step builder to generate the code needed to interact with the generated runtime services framework 125. For the rollback transaction step, the model deployer 120 utilizes the logic step builder to generate the code needed to interact with the generated runtime services and framework to rollback the current transaction when this step is encountered. For the throw exception step, the model deployer 120 utilizes the logic step builder to generate the code needed to interact with the generated runtime services framework 125 to throw the type of exception that was defined to be thrown in the model designer 110. The code is designed to populate the exception object with the information that was requested in the model designer 110. For the catch exception step, the model deployer 120 utilizes the logic step builder to generate the code needed to interact with the generated runtime services framework 125 to catch the type of exception(s) that were defined to be caught in the model designer 110. The code is designed to record the exception information that was requested in the model designer 110 when the step was configured. In 2035, deployment artifacts are generated. The deployment artifacts include deployment descriptors and configuration files that are necessary to register the generated logic model within the target technology infrastructure, which hosts the executing software service. Many systems require deployment descriptors which detail the naming and dependencies between executing code members. Some require configuration information to control remote availability of executing code members, etc. In 2040, the model deployer 120 utilizes the logic step builder to generate the dynamic web page that was designed within the model designer 110 for the GUI step. If necessary, in 2050, the model deployer 120 will generate any of the resources that the page used during design including images, style sheets, etc. In 2050, if necessary, the generated web page is configured with all of the scripting functions and controls needed to implement the events and actions as designed. In 2045, the model deployer 120 utilizes the logic step builder to return to 2030 to generate the code for all other step types including those that are predefined in the system as well as those that are incorporated to the system through an extension. In 2099, the process ends.

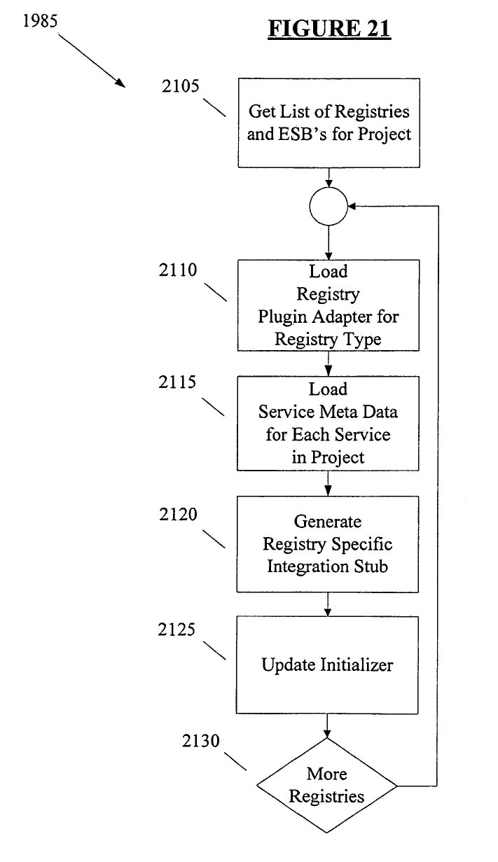

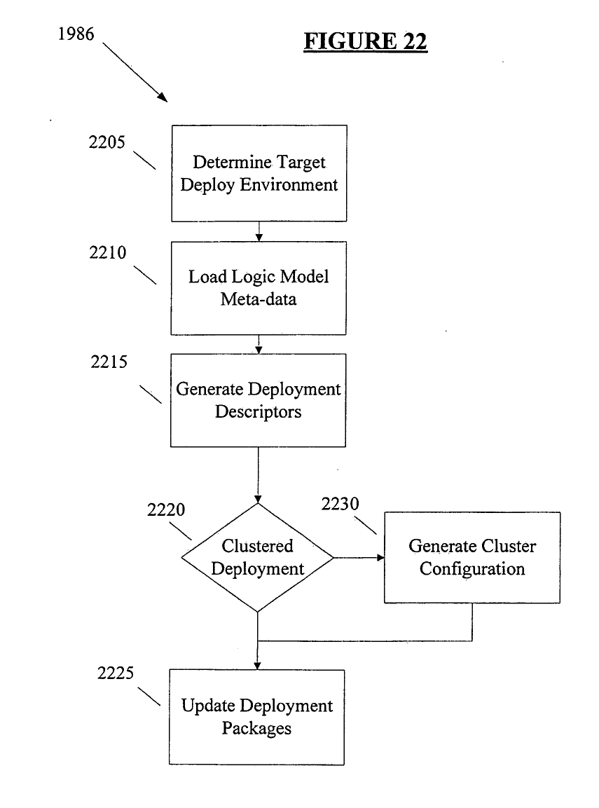

Referring to FIG. 19, In 1982, if the model is exposed as a web service or web services for remote portlets (WSRP), a WSRP descriptor file is generated for it. This file describes the service and how a remote web service client or portlet container can connect to and invoke the service. In 1983, the model deployer 120 builds a service initializer for each generated service 130 which is responsible for the initialization activities required by the generated runtime services framework 125 that is packaged with each generated project model. For example, the initializer is responsible for publishing service information to the enterprise service buses and the runtime registries that are configured in the domain. In 1984, the model deployer 120 compiles all of the source files that were generated for each project model. Each project model has its own unique package name, so the classes will be organized by project model. In 1985, the model deployer 120 appends project level meta-data to the registry bindings which are used to register the services 130 with each generated project model to the enterprise service buses and runtime registries that are configured with the domain. More details are provided concerning this operation with regard to FIG. 21. In 1986, the model deployer 120 builds the top level descriptors needed for each project model. Each project model is packaged and deployed as a separate application in its own deployable file. The model deployer 120 tailors the descriptor generation to the target technology infrastructure 145. More details are provided concerning operation 1986 with regard to FIG. 22. In 1987, it is determined if there-are any more project models. If yes, the process returns to 1955 and repeats. If no, the process moves to 1988, and the domain is packaged and prepared for final delivery to the target technology infrastructures 145. The model deployer 120 can have a pluggable packager architecture. It can have a separate packaging class for each supported application server and platform. In 1989, the model deployer 120 delivers the domain to the target technology infrastructures 145. In one embodiment, this only happens for automatic deploys. For scripted deploys, the model deployer 120 skips the delivery: In 1990, the process ends.

FIG. 21 illustrates the details of registering a project model, as set forth in 1985 of FIG. 19, according to one embodiment of the invention. In 2105, a list of registries and enterprise service buses is obtained. In 2110, the generated services 130 are configured and deployed with information that can be used to automatically register and de-register the services 130 as they become available in the domains. In 2115, service data for each service in the project model is loaded. In 2120, the model deployer 120 will generate and package the information needed to register the services 130 with one or more runtime registries or enterprise service buses when the project model loads into memory and can optionally de-register the service 130 when the project model becomes unavailable in the domain. In 2125, the initializer is updated with the details of the ESB or registry so that the deployed project will contain the configuration files and executable files needed to publish information to that registry. In 2130, it is determined if there are more registries. If so, the process returns to 2110 and repeats.

FIG. 22 illustrates details of building descriptors, as set forth in 1986 of FIG. 19, according to one embodiment of the invention. In 2205, the target environment in which service 130 is to be deployed is determined. In 2210, the logic model data is loaded. In 2215, the model deployer 120 will generate the deployment descriptors and other deployment artifacts that are needed to configure and deploy the generated project model and its services. The deployment artifacts include deployment descriptors and configuration files that are necessary to register the generated data objects and logic models as well as the other generated items that are included with the software services within the target technology infrastructure which hosts the executing software service. Many systems require deployment descriptors which detail the naming and dependencies between executing code members. Some require configuration information to control remote availability of executing code members, etc. This step is responsible for determining the appropriate configuration modifications that are required to deploy services 130 within a fault tolerant environment. In 2220, it is determined whether the deployment is a clustered deployment. A clustered environment is an environment where system resources and software services are delivered within a technology infrastructure which ensures redundancy of execution and fail over of service invocations in the event of a catastrophic loss of operating resources or downed environment. A clustered deployment includes cluster aware configurations as well as fail-over preferences and load balancer URL configuration options. When deploying to a fault tolerant environment the deployment must be configured to integrate with the components of the underlying technology infrastructure which manages redundancy and fail over. This configuration may be specialized for each generated artifact and is specific to each technology platform. If it is a clustered (i.e., fault tolerant) deployment, in 2230, the cluster configuration is generated. In 2225, the deployment package is updated.

FIG. 23 illustrates details of executing the service, as set forth in 1515 of FIG. 15, according to one embodiment of the invention. In 2305, available project models and services are received. In 2310, runtime registries and enterprise service buses are notified that the generated software services have become available and information about the software services is automatically published to the runtime registries and enterprise service buses which were configured within the domain model. The information that is published to the registry and the protocol and standard used in the publishing is configurable and customizable within the system. In 2315, the runtime is executed.

FIG. 24 illustrates details of executing the runtime, as set forth in 2315 of FIG. 23, according to one embodiment of the invention. When the runtime is executed, the web browser and web server interact to provide a dynamic user interface that can be utilized by the user. A dynamic user interface refers to the capability of being able to change the interface at the browser without interacting with the web server. In 2405, the user clicks the button to execute the service 130. In 2410, server action is invoked. The generated service user interface is, preconfigured to invoke the web controller responsible for manager the invocation of server actions which are actions that are implemented as a set of execution steps in the web model. In 2415, the runtime web layer loads the generated instance of the web model and then proceeds to bind any data from the web browser that is being used to set the variables of the web model prior to the execution of the server action. In 2420, the data that was sent in from the web browser as a part of the HTTP request is bound into the variables of the logic model or web model that is being executed so that those new variable values can be included in processing of the logic. In 2425, the web runtime requests the logic runtime to execute the logic steps that were specified in the web model during the design phase. The logic tier loads the server action as it was defined and executes the logic steps that it contains. The server action can be configured to invoke other logic models as well as executing its own steps.

Following the invocation of the server action, the load component action 2430 will be executed and will cause one of the UI components from a web model to be dynamically loaded into the web page. The load component action is the second action that was designed within the model designer to be performed when a user clicks on this button. Each user interface event can trigger many actions. The load component action 2430 invokes the scripting language that was generated into the HTML page by the model deployer to make an HTTP request to the executing software service to load a specific web model component. The HTTP request reaches the web tier that is packaged as a part of the runtime services framework to receive this request. The web tier first checks to the component to determine whether the request is for a component in the same project and software service or whether the request is for a component in a separate project and software service which may be located on a separate physical system 2445. If the component is not local, in 2450, its URL is requested from the runtime registry which has been configured to work with this software service. The web tier then forwards the request to the appropriate server in 2455. If the component is local, in 2460, the tier loads the web model into memory and initializes that web model instance for use. The web tier then retrieves information that was sent with the HTTP request that represents values being passed into the software service from a web browser form or hyperlink and binds that data in 2465 to the variables that are being utilized in the web model. Once set, these variables will effect the execution and outcome of the web model. In 2470, the web tier requests that the web model execute the pre-steps of the web component. The pre-steps are the logic steps that occur prior to the GUI step in the web component. In 2475, the web tier loads the content of the GUI step by invoking the dynamic web page as it was generated by the model deployer. The dynamic web page may include static and dynamic content and may utilize the variables of the web model to generate its content. The dynamic web page represents the GUI step as it was configured and designed within the GUI step designer 958. The page may contain one or more custom tags 934 which are injected into the dynamic page as representations of the GUI widgets 936 that were configured in the GUI widget designer(s) 936. As the web tier loads the dynamic web page, its tags are processed and each tag's tag handler is invoked at 2480. Once the dynamic content has been created in the web tier, the content is returned to the browser in 2485. In 2490, the content is received by the web browser and then inserted by the load component handler into the layer on the web page that was designated when designing the load component action in the model designer. In 2435, the load component action completes its execution by changing the visibility of the layer where the content was loaded. This is achieved using the visibility flag or style on that layer as prescribed by the HTML specification(s). In 2440, the dynamic content is made visible to the end user through the web browser interface.

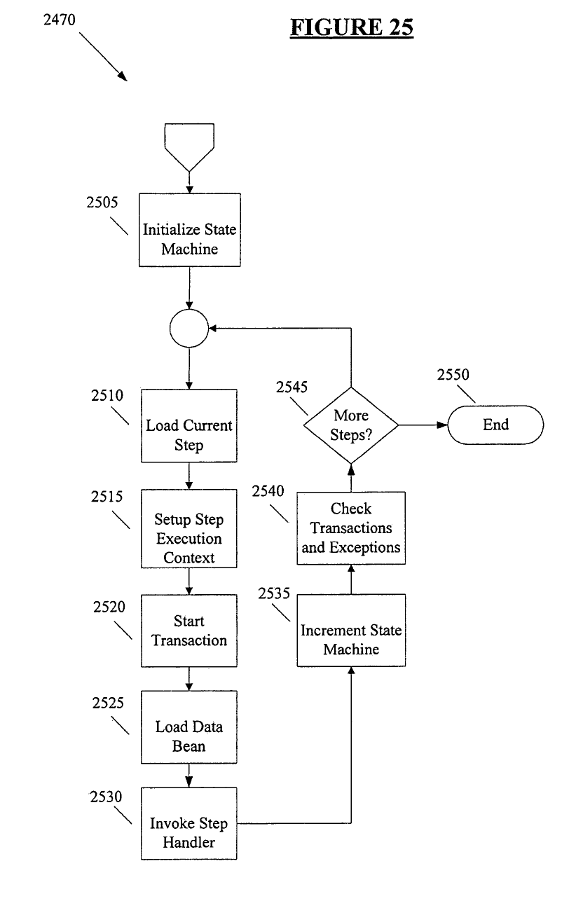

FIG. 25 illustrates details of the request logic tied to execute pre-steps, as set forth in 2470 of FIG. 24. In 2505, the state machine is initialized. Once initialized, the state machine will guide the execution of the logic model and will control the flow of execution as it was designed in the model designer 110. In 2510, the generated logic model loads each step as defined and controlled by the state machine. In 2515, the step execution is set up by preparing the variables that will be used by the step and creating the data that will be passed to the step handler that represents the translation of the details configured in the step designer from within the model designer. In 2520, the transaction is started. In 2525, the data is loaded, and all of the information required by the step handler is pushed into a data bean which is an object designed to hold the information required by each step type and step handler. In 2530, the generated logic model invokes the step handler for the current step. Each step type has a corresponding step handler which is a class that does the work associated with each step type. The variable data and execution context are passed to each step handler which then incorporates that information into its execution. The information that will be passed to the step handler is determined during the design phase within the step designer which is a sub component of the logic model or web model designer which is a sub component of the model designer. In 2535, the state machine is incremented to the next appropriate state. The state of the logical execution model is dependent on the logical flow as it was designed within the model designer and the state machine is generated and executed as code that is a translation of that execution path. The state machine determines which method will be invoked next while the logic model or web model are executing. In 2540, after invoking each step handler, the generated logic model will validate the transaction state and determine whether or not there are any errors or exceptions and validate that the transaction has not been rolled back. The state machine is updated in either case to either move the execution forward or route the exception to the appropriate exception handling step as defined in the logic model. In 2545, it is determined if there are any additional steps. If yes, the process returns to 2510 and repeats. If no, the process moves to 2550 and ends.

### CONCLUSION

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. In fact, after reading the above description, it will be apparent to one skilled in the relevant art(s) how to implement the invention in alternative embodiments. Thus, the present invention should not be limited by any of the above-described exemplary embodiments.

In addition, it should be understood that the figures, examples, and screen shots, which highlight the functionality and advantages of the present invention, are presented for example purposes only. The architecture of the present invention is sufficiently flexible and configurable, such that it may be utilized in ways other than that shown in the accompanying figures, examples, and screen shots.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

1. A method of utilizing a service, comprising:
a. designing the service in a visual modeling environment such that low level machine centric and/or platform dependent programming language is not used, the service capable of being implemented across an enterprise; and
b. deploying the service in a plurality of technology infrastructures in a manner that interacts with enterprise software and/or other technology infrastructures within the enterprise by tailoring the service for each such infrastructure.

2. The method of claim 1, wherein the capabilities of the service comprise:
a. transaction control;
b. fault tolerance;
c. exception handling;
d. logic execution
e. logging integration;
f. runtime registry publication;
g. enterprise service bus publication;
h. or any combination thereof.

3. The method of claim 1, wherein the service allows interaction of multiple supporting software platforms within atomicity, consistency, isolation, and durability (ACID) based transactions.

4. The method of claim 1, wherein the service is capable of being deployed in a fault tolerant environment.

5. The method of claim 1, wherein the service is capable of model-based exception handling.

6. The method of claim 1, wherein the service is capable of logging integration with the enterprise software and/or the other technology infrastructures within the enterprise.

7. The method of claim 1, wherein the service is capable of being published to runtime registries and/or enterprise service buses.

8. The method of claim 1, wherein the technical infrastructure of the deployment environment is capable of being extended and/or customized such that:
a. any type of technical environments can be plugged into the deployment environment for use; and/or
b. multiple technical infrastructures can be plugged into the deployment environment simultaneously for use.

9. The method of claim 1, wherein the modeling environment is capable of being extended and/or customized such that:
a. new components can be plugged into the modeling environment to enable the creation and modification of new entities within the model; and/or
b. new components can be plugged into the modeling environment to enable the generation, of source code by the modeling environment

10. The method of claim 1, wherein the service utilizes Rich Internet application capabilities.

11. The method of claim 10, wherein the Rich Internet application capabilities comprise rich dynamic user interfaces.

12. The method of claim 11, wherein the rich dynamic user interfaces are: synchronous and/or asynchronous.

13. A method of utilizing a service, comprising:
a. designing a service in a visual modeling environment such that low level machine centric and/or platform dependent programming language is not used, the service utilizing Rich Internet application capabilities; and
b. deploying the service in a plurality of technology infrastructures in a manner that utilizes the Rich Internet application capabilities by tailoring the service for each such infrastructure.

14. The method of claim 13, wherein the Rich Internet application capabilities comprise rich dynamic user interfaces.

15. The method of claim 14, wherein the rich dynamic user interfaces are:
a. synchronous; and/or
b. asynchronous.

16. The method of claim 1, wherein only changed items in the service are deployed.

17. The method of claim 1, wherein previous deployment states from previously deployed services are capable of being restored.

18. The method of claim 1, wherein the service is validated to check for errors and/or issues in design and/or implementation.

19. The method of claim 1, wherein dependencies between various components in services are provided in the visual modeling environment.

20. The method of claim 1, wherein the service is tailored to the technology infrastructure where the service is executed.

21. The method of claim 1, wherein different versions of the service and/or a part of the service can be built, accessed, utilized, and/or edited by the user.

22. The method of claim 1, wherein the different users can build, utilize, access, and/or edit the service and/or a part of the service at the same time.

23. The method of claim 1, wherein the service and/or a part of the service can be combined and/or orchestrated with other services and/or parts of the service in the visual modeling environment.

24. The method of claim 1, wherein the designing comprises:
a. creating a project model, the project model including a project name and the service; and
b. creating a runtime framework representing a location and resources of a technology infrastructure which will receive a project created from the project model.

25. The method of claim 24, wherein the service includes implementation details, comprising:
a. a data object;
b. a data store;
c. an exception definition;
d. a logic model;
e. a web model; or
f. any combination thereof.

26. The method of claim 24, wherein the deploying comprises:
a. building a project utilizing the project model;
b. delivering the project to technology infrastructure utilizing the runtime framework.

27. A system for utilizing a service, comprising a computer with an application for:
a. designing the service in a visual modeling environment such that low level machine centric and/or platform dependent programming language is not used, the service capable of being implemented across an enterprise; and
b. deploying the service in a plurality of technology infrastructures in a manner that interacts with enterprise software and/or other technology infrastructures within the enterprise by tailoring the service for each such infrastructure.

28. The system of claim 27, wherein the enterprise class capabilities comprise:
a. transaction control;
b. fault tolerance;
c. exception handling;
d. logging integration;
e. runtime registry publication; or
f. enterprise service bus publication; or
g. logic execution; or
h. any combination thereof.

29. The system of claim 27, wherein the service allows interaction of multiple supporting software platforms within atomicity, consistency, isolation, and durability (ACID) based transactions.

30. The system of claim 27, wherein the service is capable of being deployed in a fault tolerant environment.

31. The system of claim 27, wherein the service is capable of model-based exception handling.

32. The system of claim 27, wherein the service is capable of logging integration with the existing enterprise system and/or other technology infrastructures.

33. The system of claim 27, wherein the service is capable of being published to runtime registries and/or enterprise service buses.

34. The system of claim 27, wherein the modeling environment and the deployment are capable of being extended and/or customized.

35. The system of claim 27, wherein the service utilizes Rich Internet application capabilities.

36. The system of claim 35, wherein the Rich Internet application capabilities comprise rich dynamic user interfaces.

37. The system of claim 36, wherein the rich dynamic user interfaces are:
a. synchronous; and/or
b. asynchronous.

38. A system of utilizing a service, comprising a computer with an application for:
a. designing a service in a visual modeling environment such that low level machine centric and/or platform dependent programming language is not used, the service utilizing Rich Internet application capabilities; and
b. deploying the service in a plurality of technology infrastructures in a manner that utilizes the Rich Internet application capabilities by tailoring the service for each such infrastructure.

39. The system of claim 38, wherein the Rich Internet application capabilities comprise rich dynamic user interfaces.

40. The system of claim 39, wherein the rich dynamic user interfaces are:
a. synchronous; and/or
b. asynchronous.

41. The system of claim 27, wherein the designing comprises:
a. creating a project model utilizing the project model including a project name and the service; and
b. creating a runtime framework representing a location and resources of a technology infrastructure which will receive the project model.

42. The system of claim 41, wherein the service includes implementation details, comprising:
a. a data object;
b. a data store;
c. an exception definition;
d. a logic model;
e. a web model; or
f. any combination thereof.

43. The system of claim 40, wherein the deploying comprises
a. building a project utilizing the project model;
b. delivering the project model to the technology infrastructure utilizing the runtime framework.

44. The system of claim 27, wherein only changed items in the service are deployed.

45. The system of claim 27, wherein previous deployment states from previously deployed services are capable of being restored.

46. The system of claim 27, wherein the service is validated to check for errors and/or issues in design or implementation.

47. The system of claim 27, wherein dependencies between various components in services are provided in the visual modeling environment.

48. The system of claim 27, wherein the service is tailored to the technology infrastructure where the service is executed.

49. The system of claim 27, wherein different versions of the service and/or a part of the service can be built, utilized, accessed, and/or edited by the user.

50. The system of claim 27, wherein the different users can build, utilize, access, and/or edit the service and/or a part of the service at the same time.

51. The system of claim 27, wherein the service and/or a part of the service can be combined and/or orchestrated with other services and/or parts of the service in the visual modeling environment.

52. The method of claim 21, wherein different parts of the service can be versioned independently of each other.

53. The system of claim 49, wherein different parts of the service can be versioned independently of each other.
